(19) United States
(12) Patent Application Publication
(10) Pub. No.: US 2019/0382042 A1
(43) Pub. Date: Dec. 19, 2019

(54) CATERING TRUCK ON AEROPLANE

(71) Applicant: Zuoliang WANG, GUANGZHOU, GUANGDONG (CN)

(72) Inventor: Zuoliang WANG, GUANGZHOU, GUANGDONG (CN)

(21) Appl. No.: 15/518,744

(22) PCT Filed: May 25, 2015
(86) PCT No.: PCT/CN2015/079696

§ 371 Date: May 27, 2017

(51) Int. Cl. B62B 3/02; A47B 31/06; B62B 3/06

(52) U.S. Cl. CPC B62B 3/02; A47B 31/06; B67D 1/04; B62B 2202/67; B62B 2203/10; B62B 3/0606

(57) ABSTRACT

Disclosed is a catering truck on an aeroplane. Drink pots are designed on the catering truck. Each drink pot holds a different liquid drink. Each drink pot corresponds to one faucet. A flight attendant pours drinks for passengers by means of a faucet switch. Four technical solutions are included: a catering truck travelling on the corridor floor of an aeroplane; a catering truck travelling while hanging on a central rail in the ceiling right above the corridor floor of an aeroplane; a catering truck travelling while hanging on a side rail in the ceiling oblique above the corridor floor of an aeroplane; and a catering truck travelling while hanging on a rail on the luggage rack of an aeroplane. Meanwhile, further proposed is a design concept of storing a catering truck in the ceiling or the luggage rack.

### BACKGROUND

### 1. Technical Field

This invention relates to a catering truck on aeroplane, which is a small cart for use by cabin crew inside the aircraft for transport of liquid drinks, food and other items during a flight. When the cabin attendants are busy serving the passengers with the catering truck, it is possible that they spill liquid drinks on the floor or the passengers. Considering that the food service trucks are usually of considerable sizes, when the cabin attendants use food service trucks in the cabin, passengers may have difficulties in passing the corridor smoothly. The invention is to tackle the said problems.

### 2. Description of Related Art

The existing airline food service trucks are designed for the convenience of cabin attendants to provide food to passengers without taking the special demands of passengers for liquid drinks into consideration. In fact, passengers usually require food service every 4 hours. In addition, since the air carriers usually provide solid food, it is convenient and takes little time and effort to deliver. In contrast, there are usually passengers requiring liquid drinks every other hour. Moreover, since the liquid drinks may spill during delivery, the cabin attendants have to be extraordinarily careful and spend extra time and efforts during the process. Since the existing airline food service trucks are not equipped with any devices for cabin attendants to pour drinks for passengers, carton-pack liquid drinks are supplied and therefore cabin attendants have to serve passengers with the liquid drinks from the carton packs, which is likely to cause three problems as follows: First, since most liquid drinks are packaged in cartons which are soft, it is relatively difficult to pour the liquid drinks into disposal cups when the liquid drinks are full as the carton packs are just opened without spilling the liquid drinks on the floor or even the passengers; second, there is considerable vacancy in the large food service trucks, indicating that the liquid drink service trucks have a low utilization rate when cabin attendants serve passenger; third, the food service trucks of relatively large sizes almost occupy the entire corridor and passengers cannot pass the corridor. Therefore, in this author's opinion, the catering truck on aeroplane should be designed to facilitate cabin attendants' serving passengers with liquid drinks. Another solution is to design a catering truck especially for liquid drink service or for both liquid drink and food services in a more convenient way.

### SUMMARY

The invention mainly solves technology problems that cabin attendants may accidentally spill liquid drinks on passengers when they are busy serving passengers with liquid drinks under heavy workload. The invention also solves technology problems that the corridor may become obstructed by a catering truck and the catering truck may occupy the limited space of a cabin when it is stored on the corridor floor of the cabin. The invention aims to assist cabin attendants in serving passengers with food and liquid drinks in a more efficient, faster and easier manner.

Four technical solutions are offered by this invention:

The first technical solution is a traditional catering truck that travels along the corridor. The bottom board 7 of the compartment of the catering truck that travels along the corridor floor ascends horizontally and lifts the meals in the compartment horizontally for cabin attendants to fetch the meals over the catering truck. The design effectively raises the utilization rate of the space of the cabin and facilitates the service of cabin attendants. The ascending and descending of the bottom board 7 of the catering truck compartment is achieved by utilizing an “X” shaped strut. The truck compartment 2 has an ascending and descending rotary plate 8 at the top and the “X” shaped strut at the bottom. The bottom board 7 is above the “X” shaped strut. A screw 9 is under the “X” shaped strut. The ascending and descending rotary plate 8 is connected with the screw 9 by belt drive, chain drive or transmission shaft drive. The screw 9 rotates as the ascending and descending rotary plate 8 rotates. The mirror-symmetric screw threads on the screw 9 from the middle to both ends pull together or push away the bottom sides of the “X” shaped strut connected to the screw threads. The bottom board 7 ascends when pulling together the said bottom sides. The bottom board 7 descends when pushing away the said bottom sides. To solve the problem of stacking of meals, the truck compartment 2 is equipped with moving boards 10, which are placed every 2 or 3 layers of meal boxes to diffuse disperse pressure. There is a storage area for the moving boards at one side of the truck compartment 2. To solve the problem that catering trucks usually occupy too much space of the corridor, the length and width of the base 1 of the said catering truck traveling along the corridor floor of an aeroplane are identical to the length and width of the base of the existing catering trucks. The said catering truck is “I” shaped or “[” shaped when viewed from the top. The four wheels are positioned at the four corners of the “I” shape or “[” shape. The length and height of the truck compartment 2 are identical to the length and height of the existing catering truck. The width is half or less than half of the width of the corridor. The truck compartment 2 with the base 1 of the “I” shape is positioned at the center above the base 1. The truck compartment 2 with the base 1 of the “[” shape is positioned at one side above the base 1. The catering truck in this design only occupies less than half of the corridor space and passengers can pass sideways through the other half of the corridor space. To increase the efficiency of liquid drink service, different drink pots 3 are designed and the catering truck is equipped with several drink pots 3. Each drink pot 3 is filled with a different liquid drink and has a respective faucet 4. Cabin attendants pour liquid drinks for passengers with faucet switches 5. The faucet 4 is either positioned at the bottom of the drink pot 3, the liquid drink in it flowing to the faucet 4 driven by gravity, or positioned at the top of the drink pot 3, the liquid drink flowing to the faucet 4 driven by high-pressure gas. For catering truck having faucet 4 positioned above the drink pot 3, the truck compartment 2 is equipped with a high-pressure gasholder 11. The high-pressure gasholder 11 transmits the high-pressure gas through the gas pipe 13 to the upper space of the drink pot 3. The liquid drink in the drink pot 3 is delivered to the faucet 4 positioned above the drink pot 3 under the pressure of the high-pressure gas.

The second technical solution is a suspended catering truck travelling along the central rail installed in the ceiling above the corridor. The catering truck suspended and traveling along the central rail installed in the ceiling above the corridor comprises rails 19, a motor truck 20, a bracket 21, a collapsible rotary shaft 22 and a truck compartment 2. The rails 19 are built in the ceiling. The motor truck 20 is mounted on the rails 19. The wheels of the motor truck are installed in the ceiling and the body is exposed in the air under the ceiling. A gap is provided in the center of the ceiling above the corridor for the motor truck 20. The connecting piece between the wheels and the body of the motor truck travel through the gap. The body of the motor truck is a disk-like structure. The bracket 21 is installed on one side of the disk-like body, enabling rotation around the central axis of the disk-like body. The truck compartment 2 is suspended on the bracket 21. The positions of the truck compartment 2 above the corridor respectively face the left and right side of the vertical surface corresponding to the center line of the corridor when the bracket 21 rotates around the central axis of the motor truck body at 0 degree and 180 degrees. Such positions do not exceed the vertical surface of the center line of the corridor. The truck compartment 2 is positioned at the center over the corridor perpendicular with the corridor when the bracket 21 rotates around the central axis of the motor truck body at 90 and 270 degrees. The bracket 21 has a collapsible rotary shaft 22. The rotary shaft rotates inward at 90 degrees. The truck compartment 2 rotates to a position perpendicular with the corridor and then rotates at 90 degrees towards the ceiling along the collapsible rotary shaft 22 to collapse and store the catering truck in the ceiling when the catering truck is not in use. The said catering truck is designed to have supporting drink pots 3. Each drink pot 3 is filled with a different liquid drink and has a respective faucet 4. Cabin attendants pour liquid drinks for passengers with faucet switches 5.

The third technical solution is another suspended catering truck suspended on and traveling along the rails installed on either side over the corridor. The catering truck suspended on and traveling along the rails installed on either side over the corridor comprises rails 19, a motor truck 20, a bracket 21 and truck compartment 2. The rails 19 are mounted on one side of the vertical surface of the central line of the cabin corridor. The motor truck 20 is on the rails 19. The bracket 21 is connected to the motor truck 20. The truck compartment 2 is connected to the bracket 21. The motor truck 20 and the bracket 21 comprise the front and rear parts respectively positioned on the front and rear end of the truck compartment 2. The bracket 21 rotates along the connecting axis with the motor truck 20. The truck compartment 2 rotates along the connecting axis with the bracket 21, so that to make the truck compartment 2 suspended on the rails 19 in the structure as a swing. The truck compartment 2 rotates and swings towards the position of the luggage rack as effected by the bracket 21 and hangs and stores the truck compartment 2 at the luggage rack when the catering truck is not in use. The catering truck is taken off from the luggage rack and the truck compartment 2 still is suspended on the rails 19 when the catering truck is in use. The ceiling on the other side of the vertical surface of the central line of the corridor of the cabin of the aeroplane has symmetrically designed rails 19, a motor trucks 20, brackets 21 and truck compartments 2. The symmetrically designed catering trucks on both sides occupy the space on both sides of the central line above the corridor. Both truck compartments 2 do not exceed the vertical surface of the central line of the corridor. The two symmetrically designed catering trucks pass across each other above the same corridor. To meet the demand of providing catering service to economy-class passengers, the rails 19 have two or more catering trucks. The segment of the rails 19 over the airline kitchen is disconnected to form separate rails. The number of separate rails is identical to the number of the catering trucks. The separate rails slide or rotate towards either side of the cabin. The catering trucks is led off the rails 19 when the catering trucks slide to the separate rails that slide or rotate towards either side of the cabin to achieve the purpose that the catering trucks are gathered above the corridor of the kitchen, facilitating mass loading and unloading in the kitchen by cabin attendants. The said catering truck is designed to have supporting drink pots 3. Each drink pot 3 is filled with a different liquid drink and has a respective faucet 4. Cabin attendants pour liquid drinks for passengers with faucet switches 5.

The fourth technical solution is a catering truck suspended on and travelling along the rails installed on the luggage rack. The catering truck suspended on and traveling along the rails installed on the luggage rack of an aeroplane comprises rails 19, a motor truck 20 and a truck compartment 2. The rails 19 consist of an upper rail and a lower rail. The upper rail is mounted on the upper edge of the luggage rack. The lower rail is mounted on the lower edge of the luggage rack. The motor truck 20 is designed at the outer side of the luggage rack 33. The motor truck 20 is mounted on the upper and lower rails. The truck compartment 2 is on the motor truck 20. The truck compartment runs outside the luggage rack. The truck compartment 2 is stored in the luggage rack when not in use, and pulled out from the luggage rack and hung on the motor truck 20 when in use. The motor truck 20 is a square frame mounted between the upper and lower rails at the outer side of the luggage rack. The upper suspended roller wheels 34 and lower suspended roller wheels 35 are installed in the inner side of the frame. Concave guide ways 36 are installed on the side boards on both sides of the truck compartment 2. The concave guide ways 36 have flaring ends to allow the upper suspended roller wheels 34 and the lower suspended roller wheels 35 to enter the concave guide ways 36. When the truck compartment 2 is pulled out from the luggage rack, the lower suspended roller wheels 35 enter the concave guide ways 36 from the lower end. The truck compartment 2 slides to the lowest position as guided by the lower suspended roller wheels 35 and the concave guide ways 36, and the lower suspended roller reaches the corner at the top of the concave guide ways 36. At this point, the truck compartment 2 hangs on the lower suspended roller wheels 35, and the bottom of the truck compartment 2 lies on the passenger seat below at such position and height for the purpose of placing meal boxes inside the truck compartment 2 or refilling each drink pot 3. After placing meal boxes and refilling liquid drinks, the truck compartment 2 is pushed upward. When the upper end of the concave guide ways 36 reaches the position of the upper suspended roller wheels 34, the upper suspended roller wheels 34 enter the concave guide ways 36 and reach the corner at the top of the concave guide ways 36. At this point, the truck compartment 2 is hung on the upper suspended roller wheels 34, and the lower suspended roller wheels 35 are positioned below the concave guide ways 36 to support and secure the truck compartment 2. The said catering truck is designed to have supporting drink pots 3. Each drink pot 3 is filled with a different liquid drink and has a respective faucet 4. Cabin attendants pour liquid drinks for passengers with faucet switches 5.

With the comparatively reasonable design, we optimize the efficiency of the airline food and liquid drink services, considerably reduce the area occupancy and relieve the heavy burden of cabin attendants when serving passengers. Different user-friendly catering trucks are designed to assist cabin attendants in liquid drink service, effectively improve the usage of catering trucks and optimize the service quality and efficiency. Particularly, the ideas of hanging the catering trucks in the ceiling and storing the catering trucks in the ceiling or the luggage rack not only relieve the work load of cabin attendants, but make full use of the redundant upper space in cabins, which, on the other hand, spares the floor space and assist the attendants to provide efficient catering service to passengers in a faster and easier way, indicating significant technical benefit. Since each design of catering truck has a fixed number of drink pots, air carriers will be required to at least provide different categories of liquid drinks corresponding to the quantity of drink pots, which is a new and effective method of setting standards for airline service to prevent the air carriers from reducing the categories of liquid drinks and lower the service standards for the purpose of cost reduction.

### BRIEF DESCRIPTION OF THE DRAWINGS

FIG. 1 is the perspective of the 1st embodiment of this invention.

FIG. 2 is the perspective of the 1st design of drink pots of this invention.

FIG. 3 is the perspective of the 2nd design of drink pots of this invention.

FIG. 4 is the perspective of the 3rd design of drink pots of this invention.

FIG. 5 is the perspective of the 2nd embodiment of this invention.

FIG. 6 is the perspective of the internal structure of the truck compartment of the 2nd embodiment of this invention shown in FIG. 5 used as a liquid drink service truck.

FIG. 7 is the sketch of the loaded truck compartment of the 2nd embodiment of this invention shown in FIG. 5 used as a food service truck.

FIG. 8 is the perspective of the internal structure of the truck compartment of the 2nd embodiment of this invention shown in FIG. 5 used as a food service truck.

FIG. 9 is the profile sketch of the cabin when the catering truck of the 2nd embodiment of this invention shown in FIG. 5 in use above the corridor.

FIG. 10 is the schematic diagram of the 3rd embodiment of this invention.

FIG. 11 is the perspective of the 4th design of drink pots of this invention.

FIG. 12 is the perspective of the 3rd embodiment of this invention.

FIG. 13 is the perspective of the 5th design of drink pots of this invention.

FIG. 14 is the perspective of the 4th embodiment of this invention.

FIG. 15 is the schematic diagram of the 5th embodiment of this invention.

FIG. 16 is the perspective of the 6th design of drink pots of this invention.

FIG. 17 is the perspective of the 5th embodiment of this invention with the drawers open.

FIG. 18 is the perspective of the 5th embodiment of this invention in working condition.

FIG. 19 is the perspective of the 7th design of drink pots of this invention.

FIG. 20 is the rear perspective of the drink pot shown in FIG. 19.

FIG. 20 is the resolution graph of the drink pot shown in FIG. 19.

FIG. 22 is the perspective of the 6th embodiment of this invention.

FIG. 23 is the profile sketch of the cabin when the catering truck of the 7th embodiment of this invention in use above the corridor.

FIG. 24 is the profile sketch of the cabin when the catering truck of the 7th embodiment of this invention folded and stored in the ceiling.

FIG. 25 is the perspective of the 8th design of drink pots of this invention.

FIG. 26 is the perspective of the 7th embodiment of this invention.

FIG. 27 is the sectional sketch of the cabin when the catering truck of the 8th embodiment of this invention is in service.

FIG. 28 is the sectional sketch of the cabin when the catering truck of the 8th embodiment of this invention is stored in a luggage rack.

FIG. 29 is the perspective of the 8th embodiment of this invention.

FIG. 30 is the vertical view of the kitchen when the catering trucks of the 8th embodiment of this invention gather above the corridor floor of the kitchen

FIG. 31 is the local sectional sketch of the cabin when the catering truck of the 9th embodiment of this invention is stored in a luggage rack.

FIG. 32 is the local sectional sketch of the cabin when the catering truck of the 9th embodiment of this invention is at the lower position.

FIG. 33 is the sectional sketch of the cabin when the catering truck of the 9th embodiment of this invention is in service.

FIG. 34 is the perspective of the 9th embodiment of this invention.

FIG. 35 is the perspective of the 9th design of drink pots of this invention.

Wherein, 1 refers to the base, 2 refers to the truck compartment, 3 refers to the drink pot, 4 refers to the faucet, 5 refers to the faucet switch, 6 refers to the handle of the faucet, 7 refers to the bottom board of the truck compartment, 8 refers to the lifting rotary controller, 9 refers to the screw, 10 refers to the moving board, 11 refers to the high-pressure gasholder, 12 refers to the inflator, 13 refers to the gas pipe, 14 refers to the gas valve, 15 refers to the airtight connector, 16 refers to the tube, 17 refers to the watertight connector, 18 refers to the faucet connector, 19 refers to the pair of rails, 20 refers to the motor truck, 21 refers to the bracket, 22 refers to the collapsible running axis, 23 refers to catering truck 1, 24 refers to separate rail 1, 25 refers to catering truck 2, 26 refers to separate rail 2, 27 refers to catering truck 3, 28 refers to separate rail 3, 29 refers to catering truck 4, 30 refers to separate rail 4, 31 refers to the kitchen, 32 refers to the restroom, 33 refers to the luggage rack, 34 refers to the upper suspended wheels, 35 refers to the lower suspended wheels and 36 refers to the concave guide ways.

### DESCRIPTION OF THE EXEMPLARY EMBODIMENTS

The 9th embodiment is preferred in this invention.

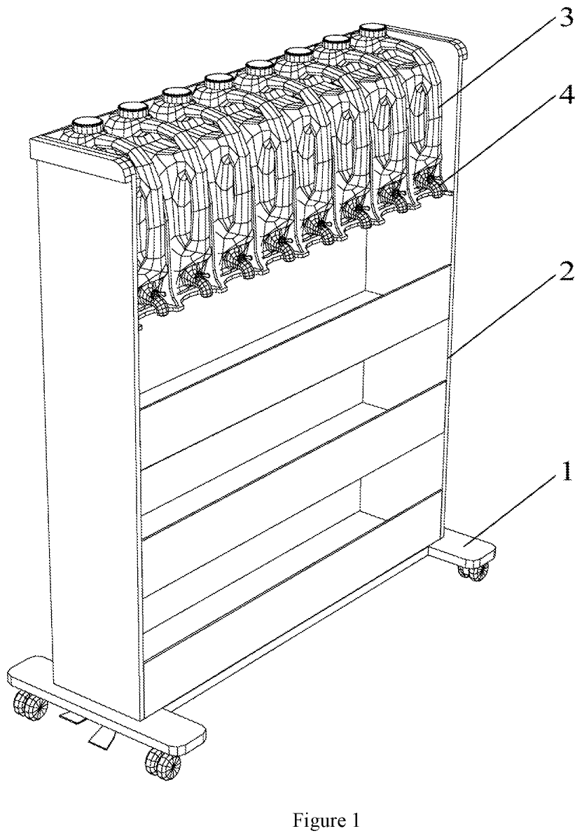

As shown in FIG. 1, it is the perspective of the 1st catering truck embodiment of this invention. The simple design is the prototype of this invention. The catering truck has combined the appearance elements of the existing airline food service trucks. With several drink pots on it, the catering truck is mainly composed of a base 1, a truck compartment 2 and the drink pots 3. The truck compartment 2 is mounted on the base 1 and the drink pots 3 are placed in the truck compartment 2. At the bottom of each drink pot 3, there is a faucet 4 and a faucet switch 5.

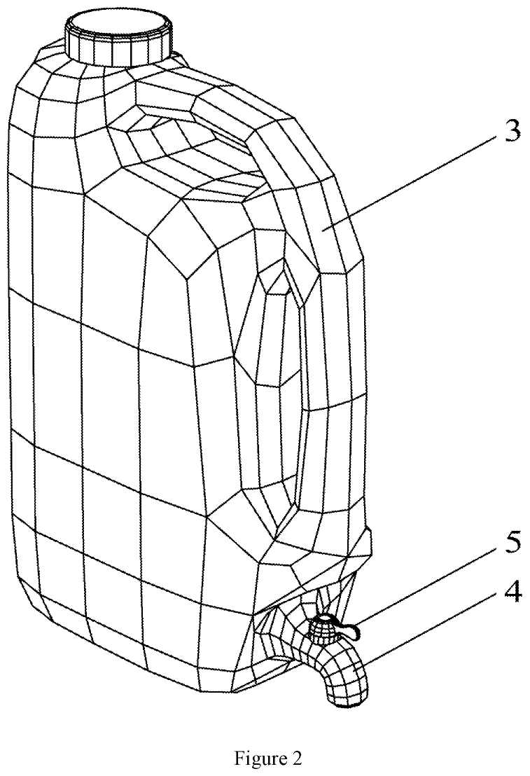

As shown in FIG. 2, it is the perspective of the 1st design of drink pots of this invention, namely, the perspective of the drink pots in FIG. 1. There is a faucet 4 at the bottom of the drink pot 3 equipped with a faucet switch 5.

It is shown in FIG. 1 that the base 1 of the 1st catering truck embodiment is relatively wide. The base of the catering truck design is of the same width as that of the existing airline food service trucks. Yet, the truck compartment 2 is narrower. According to the width of the cabin corridor, the designed width is half as wide as the corridor so that the passengers with normal body weight can easily pass sideways through the corridor. The same base composed of four wheels and a braking system of the existing catering truck on aeroplane is applied to the 1st catering truck embodiment. As shown in FIG. 1, the base 1 is in the “I” shape with the four wheels respectively distributed in the four corners of the base 1 and the truck compartment 2 in the middle of the base. The design of the base 1 can ideally fulfill multiple purposes. First of all, it improves the stability of the catering truck and prevents it from inclining due to aircraft bumpiness. Secondly, passengers can pass the corridor even though it is travelling down the corridor because either side of the catering truck can be pushed into the space under the passenger seats and run smoothly under the passenger seats, in which way, the passengers will not be bothered and the catering truck does not take up too much space of the corridor. Thirdly, the design fits the area for storage of the existing catering truck on aeroplane without changing the design of the present area of storage. In fact, the position of the truck compartment 2 can also be adjusted to either side of the base 1, which will be further introduced in the following embodiment. The width of the foregoing truck compartment 2, namely half of that of the corridor, is only an estimated value for reference. Since the width of corridors generally varies from 45-55 cm according to the aircraft models, based on the applicability and feasibility principles, to ensure that passengers can pass the corridor easily even when the catering truck is in use, the inner space of the truck compartment 2 of this invention is 20 cm wide. Considering the boards of the truck compartment, the outer truck compartment 2 is 21-22 cm wide. In other words, when the catering truck is in use, the space of 24-33 cm width at the corresponding position will be spared and the passengers with normal body weight can easily pass sideways through the corridor. The width of the truck compartment 2 can be increased. For example, 25 cm. In general, the specific width of the truck compartment 2 of this invention is less than or equal to half of the width of a corridor. Is the truck compartment 2 of 20 cm width able to satisfy the airline service demands? Firstly, in terms of the demand for liquid drink service, assumed that the inner length of the truck compartment 2 is 1 m, the catering truck will be equipped with 8 drink pots and thus there will be 8 different liquid drinks available on the aircraft, including apple juice, orange juice, Coca Cola, Sprite, purified water, tea and coffee, etc. In addition to the 8 drink pots, another 2 or more drink pots can be equipped with the catering truck to satisfy the demand for liquid drink service so that more liquid drinks such as milk and beer are available. There is no restriction about the height of drink pots. Assumed that each drink pot is 30 cm high, the volume of each drink pot reaches 7.5 L, 7.5 times of the 1 L carton-pack liquid drinks available for liquid drink service. Therefore, the drink pots are of sufficient volume to serve passengers. In fact, the design of drink pots of 20 cm long, 10 cm wide and 30 cm high with the maximum volume of 6 L is able to satisfy the demand of providing liquid drink service to a number of passengers of the economy-class passengers. Hence, the drink pots in this specific size are applied to the following embodiments. In respect of the question whether the truck compartment 2 of the designed size is able to satisfy the demand for food service, the calculation process will be provided in the following text related to other embodiments.

As shown in FIG. 1, since the truck compartment 2 of the catering truck design only occupies half floor space of the corridor, the cabin attendants can pour liquid drinks for passengers by standing in front of or at the back of the truck compartment 2. Since the faucets 4 at the bottom of the drink pots 3 also stay at either side of the truck compartment 2, the truck compartment 2 has side doors. Yet, as shown in FIG. 1, the faucet switch 5 is also at the bottom of the drink pot 3 and it is difficult for the cabin attendants to stand in front of or at the back of the catering truck to pour liquid drinks for passengers because they have to turn on the faucet switch 5 with one hand and catch the liquid drink with a cup held by the other hand under the faucet 4 at the bottom of the drink pot. Considering the limited space and the truck body, it is inconvenient for cabin attendants to serve passengers. Two solutions are provided to solve the problem. First, the faucet switch 5 is placed at the inner side of the faucet 4 and cabin attendants can directly push the faucet switch 5 inward with the disposal cup to turn on the faucet switch 5, in which case, the hardness of the disposal cup is required to meet certain standards. Second, the faucet switch 5 is placed at the top of the drink pot 3, in which case, the cabin attendants turn on the faucet switch 5 at the top of the drink pot 3 with one hand and catch the liquid drink with a cup under the faucet at the bottom of the drink pot 3 with another hand.

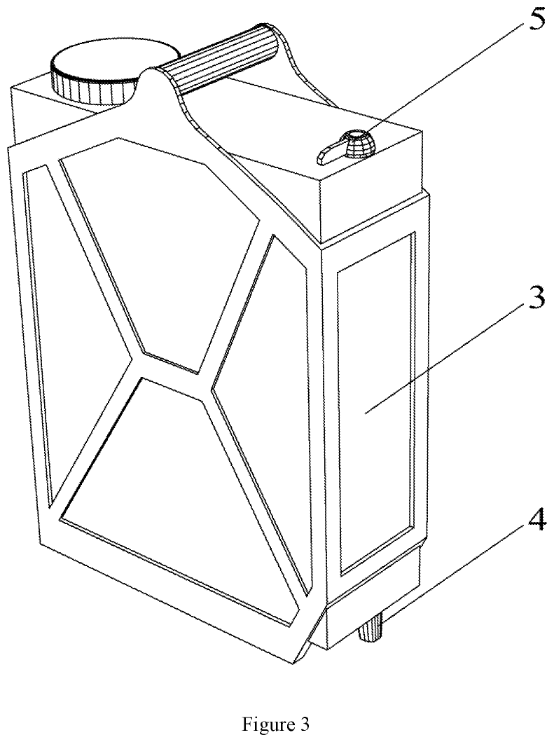

As shown in FIG. 3, it is the perspective of the 2nd design of drink pots of this invention. FIG. 3 offers another possible solution of placing the faucet switch 5 at the top of the drink pot. Yet, the design is not favorable, either, mainly because the outlet of the faucet 4 is still at the bottom of the drink pot. The cabin attendants standing in front of or at the back of the catering truck may fail to see the faucet outlet due to the limited space. Therefore, the design still requires further improvement.

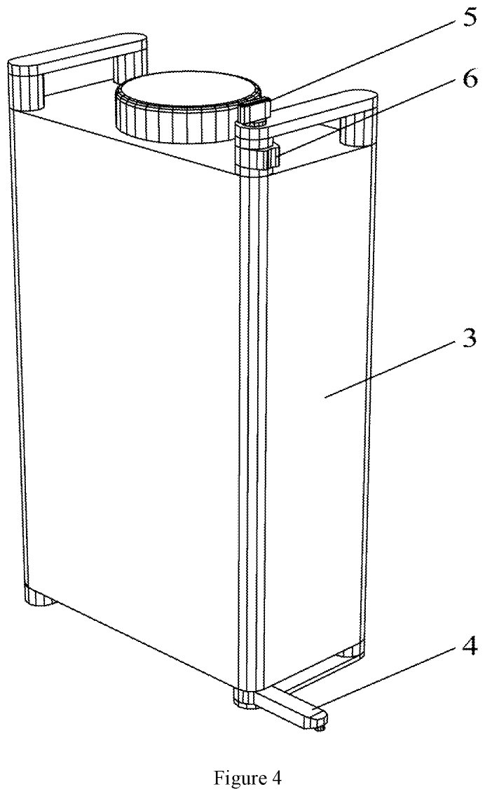

As shown in FIG. 4, it is the perspective of the 3rd design of drink pots of this invention, which provides the 3rd possible solution of placing the faucet at the bottom of the drink pot. In this solution, the drink pot 3 is a regular cuboid, which ensures the large volume and saves space. Meanwhile, it is easy to be placed orderly. Hence, the design is applicable on aircraft. There are handles at the top of the drink pot 3 and feet at the bottom. The faucet 4 is at one of the feet. When not in use, the faucet 4 is rotated around the foot horizontally at 90 degrees and be fixed at the bottom of the drink pot and between the two feet of the drink pot so that the drink pot can be easily stored and placed in the truck compartment 2. When in use, the faucet is rotated outward horizontally at 90 degrees, so that the outlet of faucet 4 stretches from the body of the drink pot and the cabin attendants can conveniently catch liquid drinks by turning on the faucet switch 5 on one of the handles at the top of the drink pot. To make it easier for cabin attendants to get access to the faucet 4 between the feet at the bottom of the drink pot, as shown in FIG. 4, there is a rotary faucet handle 6 under the faucet switch 5 on the handle at the top of the drink pot. Therefore, the faucet outlet can be rotated outward or inward horizontally by rotating the faucet handle 6 without touching the faucet outlet at the bottom of the drink pot. This design mainly aims to make it increasingly convenient to place the drink pots 3 in the truck compartment 2 and rotate the faucets 4 outward from or inward to the truck compartment 2.

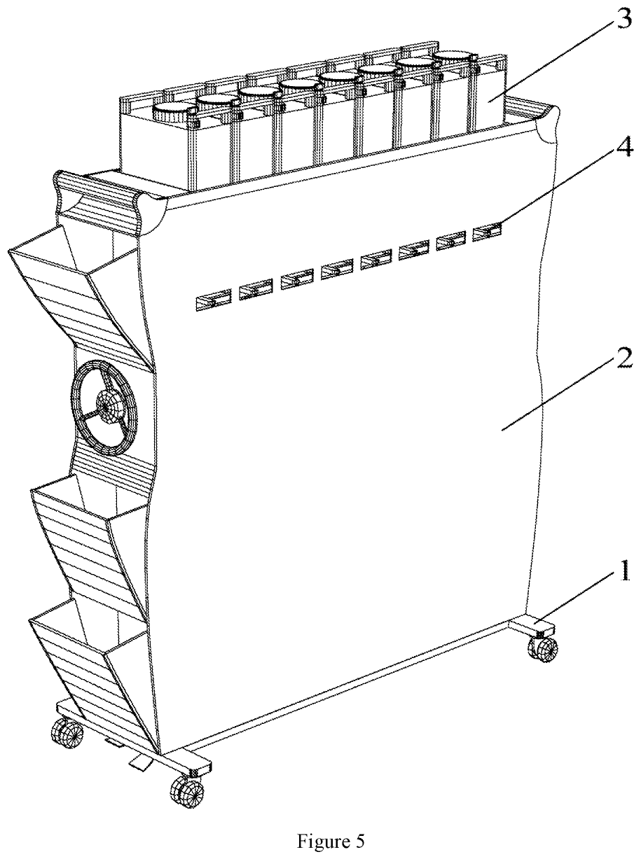

As shown in FIG. 5, it is the perspective of the 2nd catering truck embodiment of this invention, which is designed based on the drink pots shown in FIG. 4. Assumed that the internal capacity of the truck compartment 2 of the catering truck is of 80 cm long, 20 cm wide and 100 cm high and there are two small cabinets at both sides of the truck compartment 2 for the common items, such as disposal cups and napkins, etc. The faucet window is on one side of the truck compartment 2 while the drink pots 3 are placed at the back of the truck compartment 2. As shown in FIG. 4, the faucets 4 of the drink pots 3 rotate towards the faucet window so that cabin attendants can pour liquid drinks for passengers. FIG. 5 also illustrates that the width of the truck compartment 2 is smaller than that of the base 1 of the catering truck and the truck compartment 2 stays in the middle of the base 1.

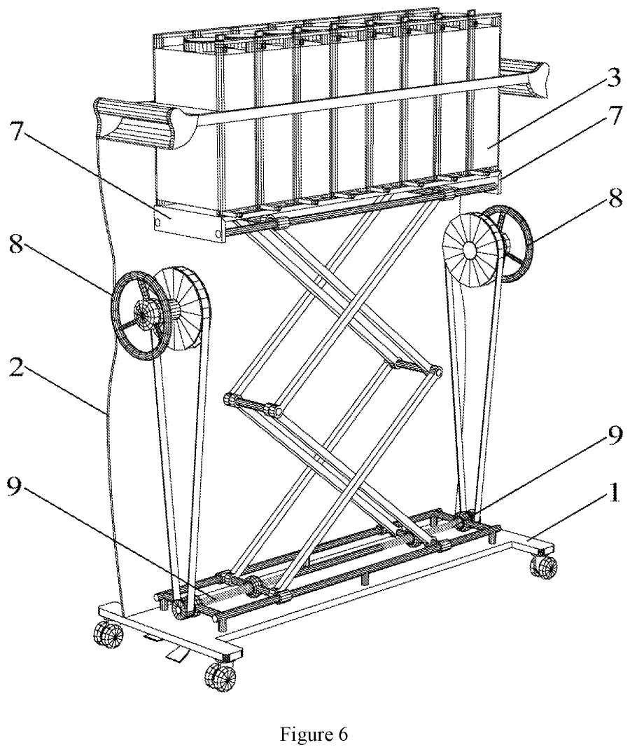

As shown in FIG. 6, it is the perspective of the internal structure of the truck compartment of the 2nd embodiment of this invention shown in FIG. 5 used as a liquid drink service truck. As shown in FIG. 6, the bottom board 7 of the truck compartment can be lifted up and brought down from the horizontal. According to the technical personnel, there are various feasible technical solutions to lift up and bring down the base from the horizontal. Specifically speaking, for this embodiment of catering truck, to steadily lift up and bring down the bottom board 7 of the truck compartment, the combination of a winch, ropes and pulleys are adopted or the bottom board 7 of the truck compartment is fixed on a chain and elevates or declines depending on the combination of runners and a chain drive. FIG. 6 offers a technical solution for the up and down of the bottom board 7 of the truck compartment by means of an “X” shaped stand. As shown in FIG. 6, there is a lifting rotary controller 8 in the truck compartment 2. The “X” shaped stand is at the bottom of the truck compartment 2 under the bottom board 7. There is a screw 9 at the bottom of the “X” shaped stand. The lifting rotary controller 8 is connected with the screw 9 by tape drive, chain drive or transmission shaft and therefore the screw 9 will drive along with the lifting rotary controller 8. There are mirror-symmetric screw threads at both ends of the screw 9 so that the “X” shaped stand connected to the screw threads can stretch or shrink. When the “X” shaped stand stretches, the bottom board 7 ascends. In opposite, when the “X” shaped stand collapses, the bottom board 7 descends. The FIG. 6 also illustrates that because there are lifting rotary controllers 8 at the front and the rear parts of the truck compartment 2, the up and down of the bottom board 7 only requires 1 cabin attendant to operate the rotary controller 8 at either side of the catering truck. To fix the bottom board 7, each lifting rotary controller 8 requires a lock with which the lifting rotary controller 8 id locked anytime. The lock can be a bolt. The cabin attendants only have to insert the bolt into the lifting rotary controller 8 to lock it; the lifting rotary controller 8 can be unlocked by directly removing the bolt. The lock can be a ratchet. When the lifting rotary controller 8 is locked by the ratchet, the cabin attendants are required to rotate the controller at the same direction to lift the bottom board 7. To release the bottom board 7, the lifting rotary controller 8 should be rotated reversely and the ratchet should be removed. These are east and feasible technical solutions acknowledged by the technical personnel in the field. These are not the only technical solution and no further details are provided herein, and the figures do not offer any further details, either. As shown in FIG. 6, when the bottom board 7 reaches a specific height, the drink pots 3 are placed on it.

The technical solutions related to the catering truck as a food service truck are provided as follows:

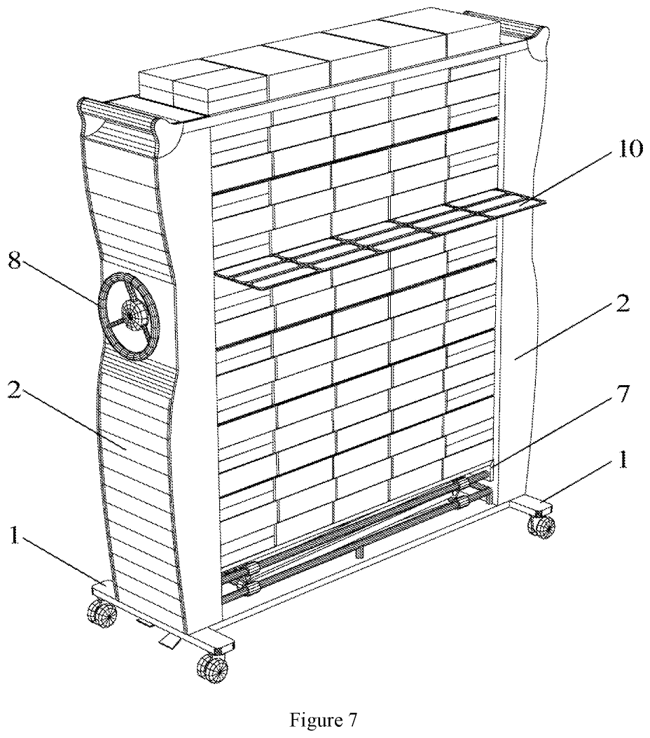

As shown in FIG. 7, it is the sketch of the loaded truck compartment of the 2nd embodiment of this invention shown in FIG. 5 used as a food service truck. As shown in FIG. 7, meal boxes are placed in the truck compartment 2 of the catering truck which mainly consists of the meal boxes of staple food and the tableware boxes. Each meal box of staple food is approximately of 15 cm long, 10 cm wide and 2.5 cm high while each tableware box is approximately of 20 cm long, 16 cm wide and 5 cm high. FIG. 7 indicates that when the catering truck is used as a food service truck, over 76 meal boxes can be loaded on the truck each time. In other words, it is a feasible design. The aircraft of medium size only requires three catering trucks of this size to satisfy the demand for food service of all passengers. Yet, since the truck compartment 2 of the catering truck only has one bottom board 7. Obviously, it cannot support the meal boxes piled up for nearly 20 layers. To solve the problem, as shown in FIG. 7, the catering truck is equipped with the moving boards 10. The moving boards 10 are thin and therefore it is required that a piece of moving board 10 be placed every 2 or 3 layers of meal boxes. To clearly illustrate the structure, one moving board 10 is intentionally pulled out from the piled up meal boxes. The moving boards 10 can significantly balance the support of the meal boxes at the lower layers and diffuse the gravity of those at the higher layers. In combination with the support of the meal boxes and the food in the meal boxes as well as the further requirements for the hardness of meal boxes, the catering truck definitely can deliver piled up meal boxes. With this specific design, cabin attendants do not have to bend over to pick up the meal boxes from the lower position of the truck compartment when delivering meal boxes to passengers. When they finish delivering the top layer of meal boxes, they can rotate the lifting rotary controller 8 and lift the meal boxes at the lower position in the truck compartment 2. It is user-friendly and convenient.

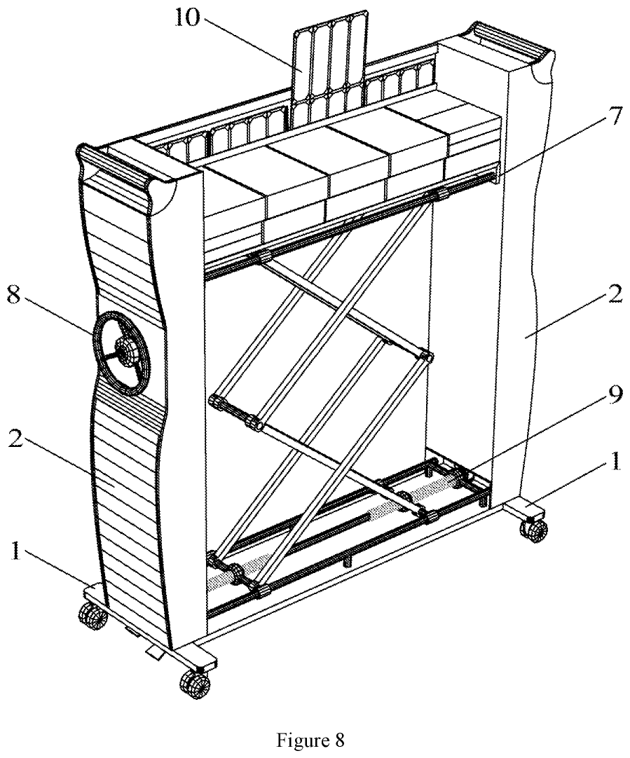

As shown in FIG. 8, it is the perspective of the internal structure of the truck compartment of the 2nd embodiment of this invention shown in FIG. 5 used as a food service truck. FIG. 8 illustrates that for the purpose of flexible placement of the moving boards 10, there is a storage area for the moving boards at one side of the truck compartment 2. Considering that the moving boards 10 are light and thin and will not take up too much space, it is feasible and convenient to set such storage area for the moving boards 10.

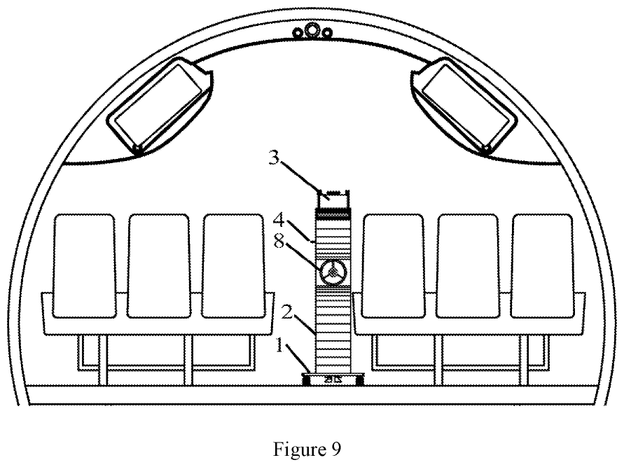

As shown in FIG. 9, it is the profile sketch of the cabin when the catering truck of the 2nd embodiment of this invention shown in FIG. 5 in use above the corridor. When in use, the wheels at the same side of the base 1 of the catering truck is pushed into the space under the passenger seats and the entire truck compartment 2 will occupy less than half of the floor area of the corridor. Therefore, the rest space will be spared and passengers can easily sidle through the corridor.

The foregoing two embodiments are common designs which take advantage of the downward flow of liquid drinks. Yet, the designs have similar limitations. Generally speaking, because the faucet outlets are at a relatively low position and the faucets are under the drink pots, cabin attendants may have difficulties to view the faucets and pour liquid drinks for passengers. The design plan of transferring the liquid drink to the faucet at the top of a drink pot by means of external force is provided as follows. One of the feasible and easy external forces is air pressure. With the high air pressure, the liquid drink at the lower level in the drink pot can be transferred the faucet at the top of the drink pot.

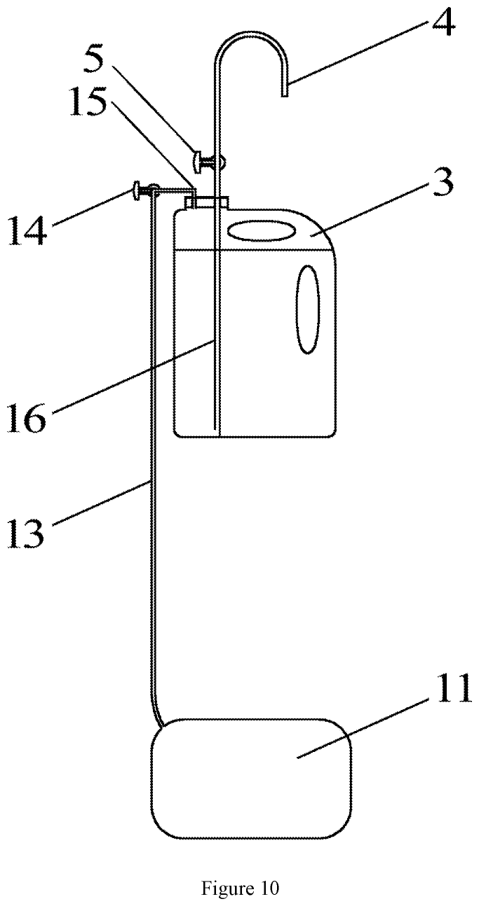

As shown in FIG. 10, it is the schematic diagram of the 3rd embodiment of this invention. According to FIG. 10, the catering truck is equipped with a high-pressure gasholder 11, which is connected with the gas pipe 13. The gas pipe 13 has a gas valve 14 while there is an airtight connector 15 on the top of the drink pot. When the gas pipe 13 is connected with the drink pot by the airtight connector 15, the gas valve 14 is open and the high-pressure air will be transferred to the upper space in the drink pot. There is an integrated faucet 4 on the drink pot. At the bottom of the drink pot, there is a tube 16. The faucet 4 is connected with the tube 16. When the liquid drink in the drink pot 3 is under high air pressure, it will be transferred to the faucet 4 at the top of the drink pot 3 from the bottom of the drink pot through the tube 16.

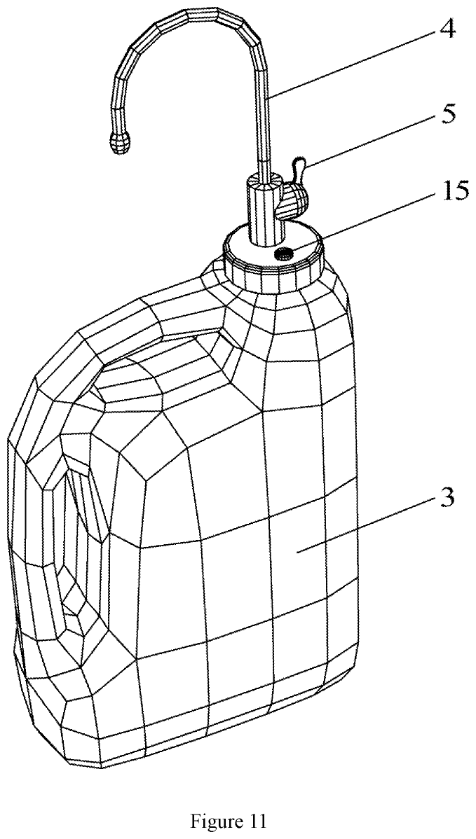

As shown in FIG. 11, it is the perspective of the 4th design of drink pots of this invention based on the schematic sketch of the drink pot 3 in FIG. 10. The drink pot has a streamline body and a lid on the top. There is an airtight connector 15 as well as a faucet 4 which is at a higher position compared to the body of drink pot.

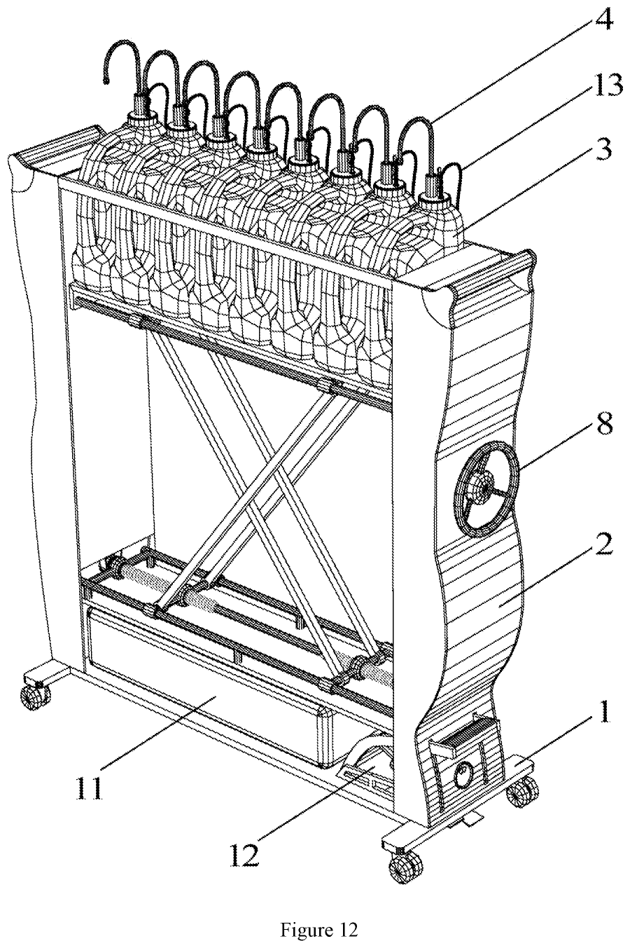

As shown in FIG. 12, it is the perspective of the 3rd embodiment of this invention based on the schematic sketch of the catering truck in FIG. 10. To clearly display the internal structure of this embodiment of catering truck, the side board at one side of the truck compartment shown in FIG. 12 is removed. FIG. 12 indicates that, there is a large-size high-pressure gasholder 11 at the bottom of the catering truck. It is commonly known that as long as the pressure in the high-pressure gasholder 11 is higher than that in the cabin, the liquid drinks at the lower position in the drink pot can be transferred to the faucet 4 at the top of the drink pot. Therefore, it is not necessary to set the high-pressure gasholder 11 at a relatively high pressure. Yet, it must have a considerably large capacity to ensure that the high pressure can be delivered to all drink pots 3 when the liquid drinks in the drink pots are all at the bottom level so that the internal gas pressure in the drink pots 3 is always higher than that of the cabin. FIG. 12 also illustrates that for the convenience of refilling the high-pressure gasholder 11, there is an integrated foot inflator 12 at the bottom of the truck compartment 2 so that the high-pressure gasholder 11 can be refilled immediately. With such design, cabin attendants can stand at either side of the catering truck and turn on any faucet switches 5 to pour liquid drinks for passengers. In case of food service, the drink pots 3 can be removed from the catering truck. Except for the high-pressure gasholder 11 and the inflator 12 at the bottom of the truck compartment that occupy certain space of the truck compartment, other structures of the catering truck is completely the same as those of the 2nd embodiment of this invention. Specifically speaking, the bottom board 7 of the truck compartment ascends or descends because the same “X” shaped stand is adopted. Cabin attendants can directly pick up the food from the truck compartment 2. When the meal boxes at the top layer are all delivered, they can lift the second layer in the truck compartment 2 by rotating the lifting rotary controller 8.

The streamline drink pot in the 3rd embodiment of this invention is the 4th design of drink pots of this invention. The drink pot has an independent faucet on the lid of the drink pot so that cabin attendants can pour liquid drinks for passengers conveniently. However, the independent faucet at the high position cause certain inconvenience of storage. Therefore, based on the 3rd design of drink pots of this invention, another design integrating the faucet and drink pot is produced.

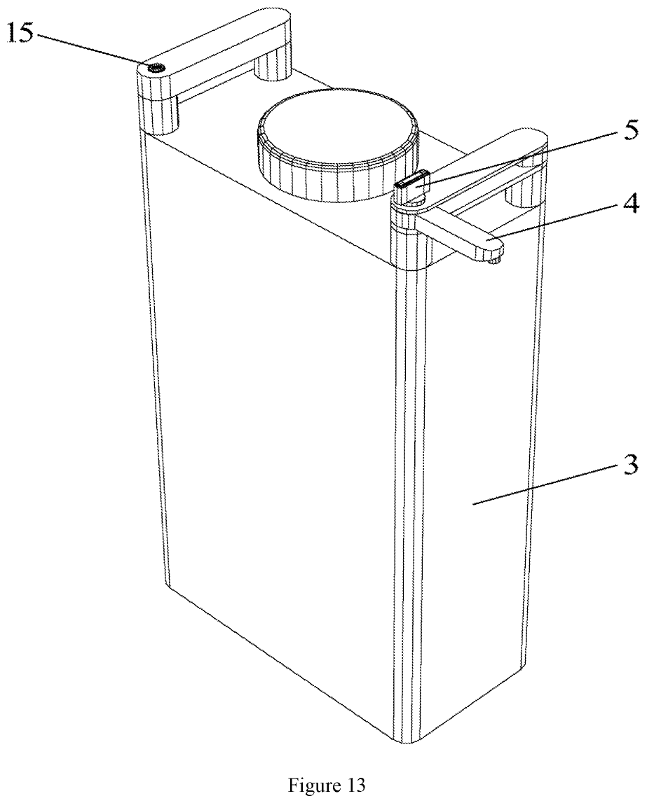

As shown in FIG. 13, it is the perspective of the 5th design of drink pots of this invention. This design also adopts the same regular cuboid shape as that of the 3rd design of drink pots with two handles on the top of the drink pot 3. The faucet 4 is placed on one of the handles. The faucet 4 rotates around the handle. When not in use, it can be rotated inward at 90 degrees and stored in the handle as part of the handle for the convenience of storage. When in use, it is rotated forward at 90 degrees so that the outlet of the faucet 4 can stretch out from the body of drink pot and the cabin attendants are able to pour liquid drinks by turning on the faucet switch 5 on the top of the handle. On the other handle of the drink pot, there is an airtight connector 15 which is used for connecting the gas pipe 13.

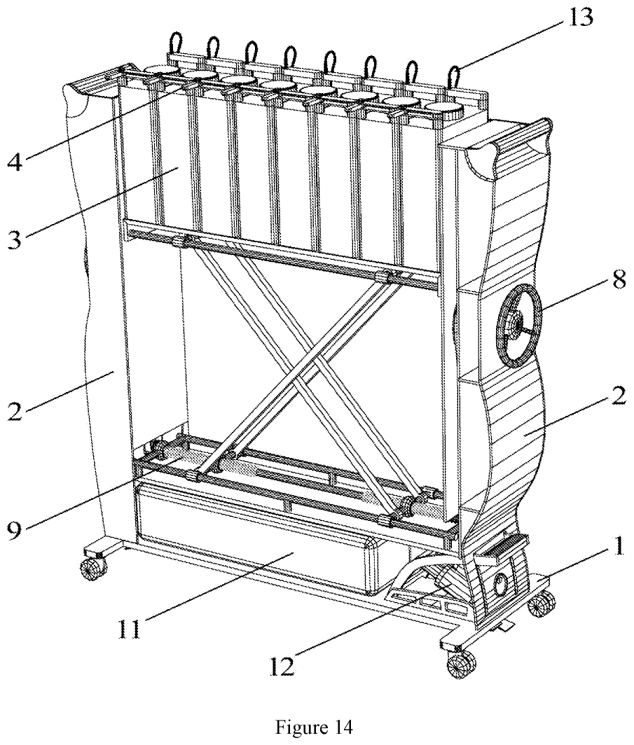

As shown in FIG. 14, it is the schematic diagram of the 4th embodiment of this invention. The catering truck of this embodiment is completely the same as that of the 3rd embodiment of this invention except that the drink pots shown in the FIG. 13, namely the 5th design of drink pots, are adopted.

The foregoing embodiments of catering trucks all combine the functions of a food service truck and a liquid drink service truck. In contrast, this invention relates to a truck that only offers liquid drink service. The embodiment of catering truck exclusively providing liquid drink service is provided as follows.

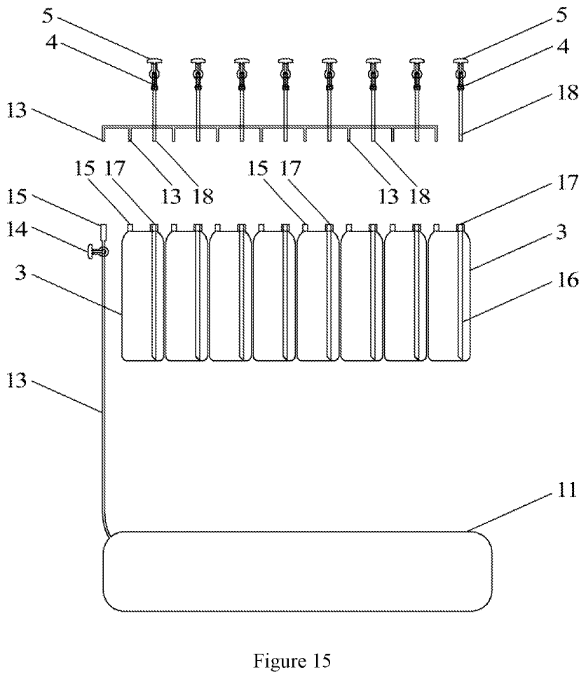

As shown in FIG. 15, it is the schematic diagram of the 5th embodiment of this invention. As shown in FIG. 15, the 5th embodiment of this invention is offered based on the same principle as that of the 3rd and 4th embodiments, which, to be specific, also transfers the high-pressure air to the top of the drink pot by means of the high-pressure gasholder 11. The gas pipe 13 is connected with the high-pressure gasholder 11 and has a gas valve 14. At the top of the drink pot, there is an airtight connector 15. When the gas pipe 13 is connected with the drink pot by the airtight connector 15, the gas valve 14 is open and the high-pressure air will be transferred to the upper space in the drink pot. The only difference lies in that, in addition to the airtight connector 15, there is also a watertight connector 17 and an independent faucet 4 separated with drink pot 3. When the airtight connector 15 is connected with the gas pipe 13, the faucet connector 18 on one end of the faucet 4 will be connected with the tube 16 by the watertight connector 17. When the liquid drink in the drink pot 3 is under high air pressure, it will be transferred to the faucet 4 at the position above the drink pot 3 from the bottom of the drink pot through the tube 16.

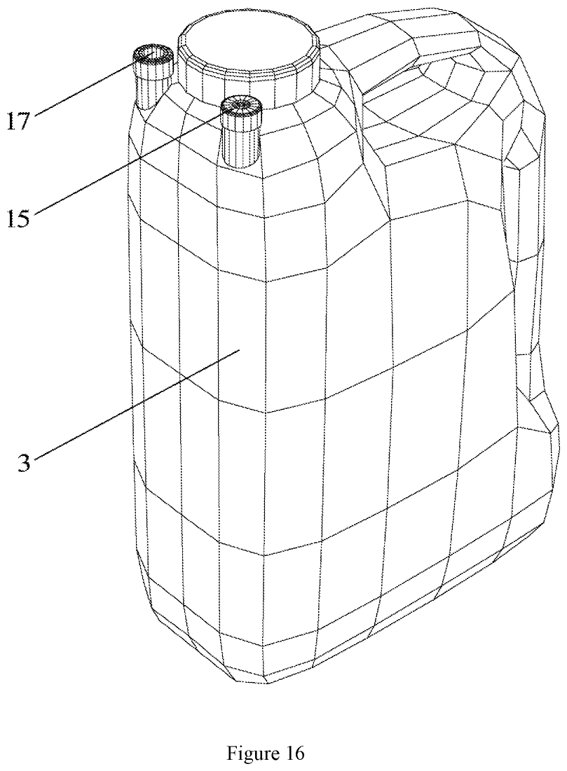

As shown in FIG. 16, it is the perspective of the 6th design of drink pots of this invention based on the schematic sketch of the drink pot 3 in FIG. 15. The drink pot has a streamline body with an independent airtight connector 15 as well as an independent watertight connector 17 at the top, which are to be connected with the gas pipe 13 and the faucet 4 respectively.

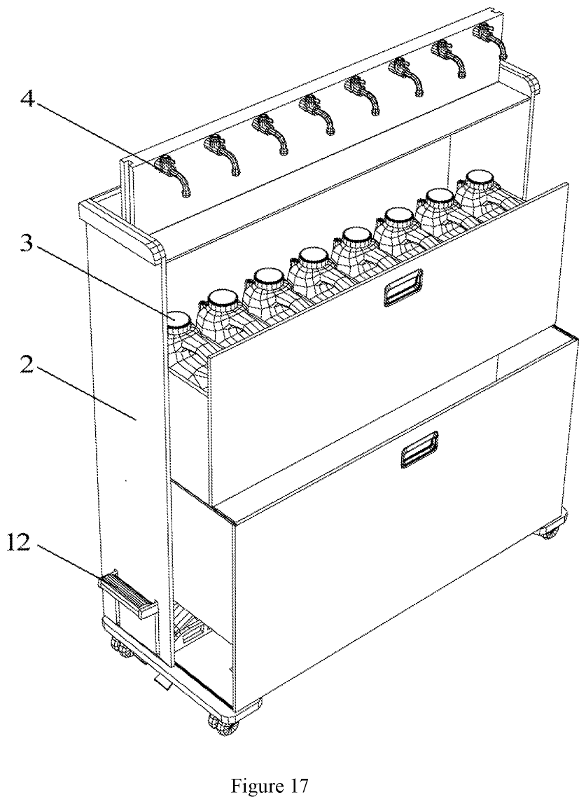

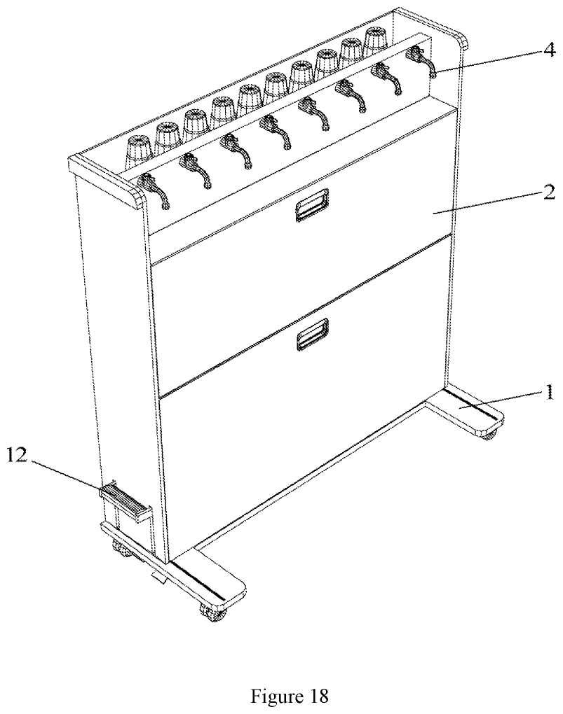

As shown in FIG. 17 and FIG. 18, the perspective of the 5th embodiment of this invention with the drawers open and the perspective of the 5th embodiment of this invention in working condition are respectively provided. The 5th embodiment of this invention is a catering truck designed based on the schematic sketch in FIG. 15. FIG. 17 mainly displays the internal structure of the catering truck by pulling out the drawers whereas FIG. 18 offers the final appearance of the catering truck put into use. As shown in FIG. 17, the 5th embodiment of catering truck is equipped with an integrated module composed of eight faucets. With the insertion design, the integrated gas pipe 13 and faucet connector 18 are installed under the integrated faucet module. With the guide ways at both sides of the truck compartment 2, when the 6th design of drink pots 3 in FIG. 16 are placed orderly and fixed in the catering truck, the integrate faucet module will be inserted from below. The gas pipe 13 is connected with the airtight connector 15 below the drink pots while the faucet connector 18 is connected to the watertight connector 17 below the drink pots so that the high-pressure gasholder 11, the faucets 4 and the drink pots 3 can be successfully connected. FIG. 17 and FIG. 18 also shown that this embodiment of catering truck is divided into three layers and four sections, including the service layer for the purpose of facilitating the cabin attendants to serve passengers, a liquid drink drawer to place drink pots under the service layer, a storage drawer under the liquid drink drawer to place other items related to the liquid drink service and the bottom where the high-pressure gasholder 11 and the inflator 12 can be found. It is a design for liquid drink service. The design of faucets 4 offers considerable convenience for operation. In addition, the workbench below the faucets 4 also makes it easier for cabin attendants to pour liquid drinks for passengers. The favorable design of man-machine interaction is user-friendly and the appearance is more appealing. As shown in FIG. 17 and FIG. 18, the base 1 of the 5th embodiment of catering truck is in the “[” shape with the width as the same as that of the existing catering truck on aeroplane. Yet, the width of the truck compartment 2 at one side of the base 1 is only equivalent to 50% of that of the corridor. The design of the base 1 is aiming to fulfill multiple purposes. First of all, it improves the stability of the catering truck, spares sufficient space to allow passengers to sidle through the corridor and fits the area for storage of the existing catering truck on aeroplane. Moreover, the design is also able to provide support for the storage drawer and the liquid drink drawer. A pair of rails are installed on the “[” shaped base 1 and wheels are installed at the bottom of the storage drawer so that it can be pulled out or pushed in smoothly. Similarly, a pair of rails are also installed on the side boards of the truck compartment and wheels are installed at the bottom of the liquid drink drawer so that it can be pulled out and pushed in conveniently. Considering the liquid drink drawer will be relatively heavy when the drink pots filled with liquid drinks are placed in it, with the design, cabin attendants can easily pull out the liquid drink drawer. Meanwhile, the rails also provide support for the heavy liquid drink drawer.

Among the foregoing embodiments, the designs relate to independent drink pots. In other words, the number of independent drink pots are added or reduced anytime. The independent drink pots are comparatively lighter and convenient and flexible when put into use. Yet, since the body of each independent drink pot is sealed, when it is filled with the liquid drinks with considerable solid substance that is attached to the wall of the body of drink pot, it will be comparatively difficult to clean the drink pot from the neck of the drink pot. Therefore, the design of an integrated drink pot module is provided to improve the convenience in cleaning and maintenance.

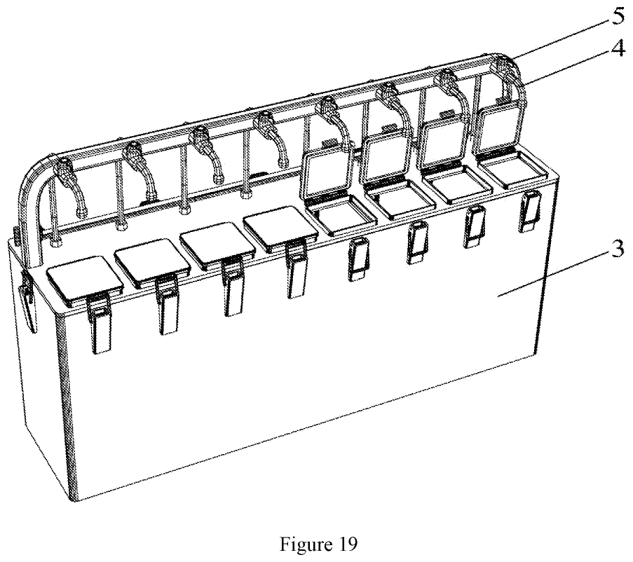

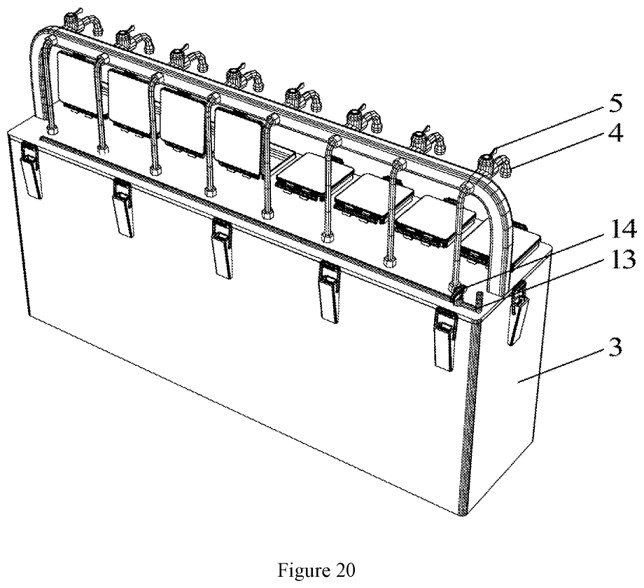

As shown in FIGS. 19, 20 and 21, they are respectively the perspective of the 7th design of drink pots of this invention, the rear perspective of the drink pot shown in FIG. 19 and the resolution graph of the drink pot shown in FIG. 19. FIGS. 19, 20 and 21 indicate the design of an integrated drink pot module composed of eight independent drink pots. The integrated open body of the drink pot module is divided into eight sections, including 5 sections filled with cold liquid drinks and the other 3 sections filled with hot liquid drinks. Thermal isolation technology is adopted to prevent heat transfer from the section of hot liquid drink to the section of cold liquid drink next to it. Each of the eight drink pots has a lid of the same length and width as the length and width of the body of drink pot. There is an independent small lid on the big lid of each drink pot. The big and small lids of each drink pot are connected to the body of drink pot by a pull buckle. The sealing strip on the lid ensures that each drink pot can be sealed separately. Above the big lids, there are the integrated gas pipes 13 and faucets 4. Meanwhile, there are tubes 16 stretching to the bottom of the drink pots below the lids. The design of drink pots as an integrated part can be put into use as a liquid drink service truck as long as it is equipped with a high-pressure gasholder.

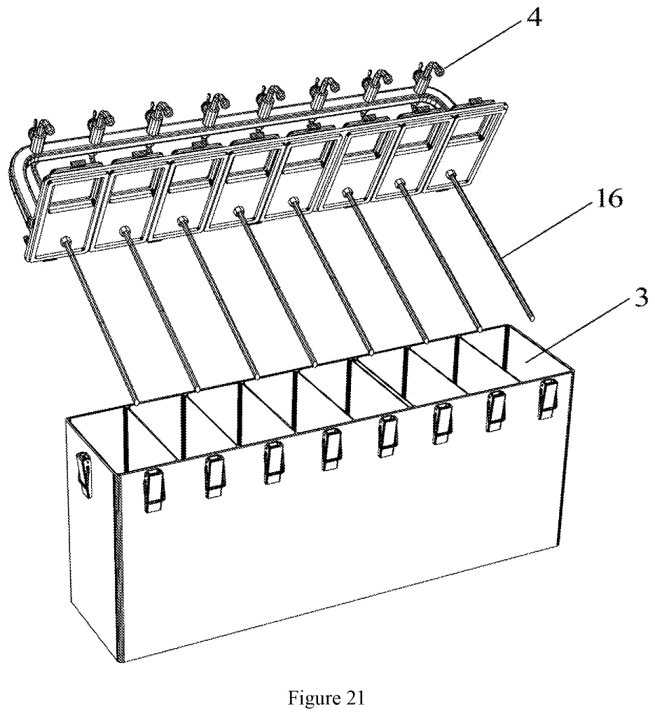

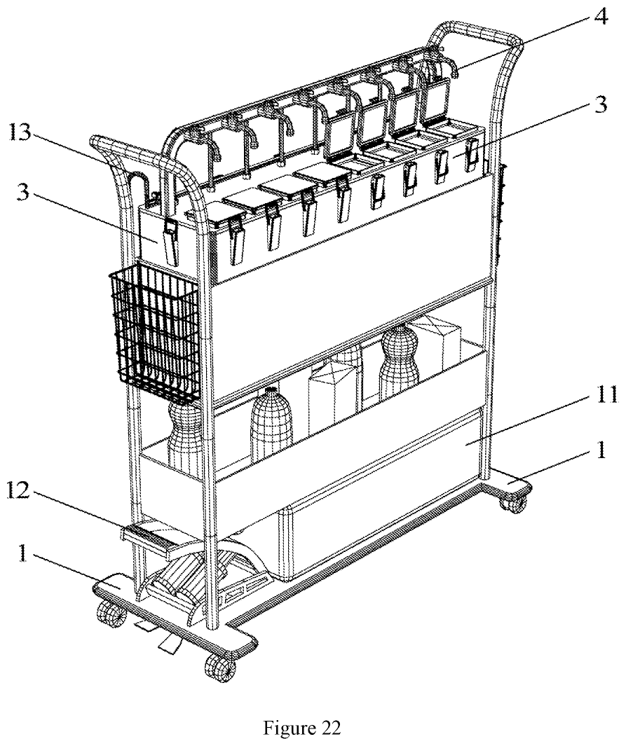

As shown in FIG. 22, it is the perspective of the 6th embodiment of this invention, which is designed based on the 7th design of drink pots. FIG. 22 indicates that it is an open truck frame consisting of three layers with the upper layer for the integrated drink pots shown in FIG. 19, the middle layer for storage of items related to liquid drinks and liquid drink service and the lower layer for the high-pressure gasholder and the inflator. When the integrated drink pots are placed on the truck frame, the drink pots can be put into use as long as the gas pipes 13 of the truck frame are connected to the gas pipes 13 of the drink pots 3.

To better solve the space occupancy of catering trucks in corridors, the designers, Seongjoo JOH and Lee Min-Joo (source: Internet) have designed a suspended catering truck hung in the ceiling of cabin. It is a new lifting smart catering truck. Yet, the design of the smart catering truck illustrates the following limitations: First, it has a limited capacity for delivery. It is commonly known that the economy class of medium or larger-size aircraft usually requires at least two catering trucks to be put into use at the same time when cabin attendants serve passengers. However, compared to the capacity of the existing catering trucks, the smart catering truck is relatively small. Further, to realize intelligent control, it is required that only one smart catering truck can be travelling on the independent rails each time. In general, every single delivery has a relatively small capacity. Second, the service is inefficient. During a two-hour flight, 4-6 cabin attendants usually have to spend over 1 hour in serving approximately 200 passengers. It is obvious that the smart catering truck cannot effectively satisfy the demand of economy-class passengers for food service within a short time. Third, the design is not user-friendly. The smart catering truck is hung on center of the ceiling and above the corridor. Considering that the cabin is approximately 2.2 meters high and the smart catering truck is 0.6 meters high and hung on the top above the corridor, the distance between the bottom of the smart catering truck and the corridor floor of cabin is only 1.6 meters, making it impossible for most passengers to pass the corridor without bending over. Fourth, the economic class is not able to provide intelligent service. Designers of the smart catering truck claimed that passengers could press the corresponding button to call for service as long as they needed any food and the smart catering truck would deliver such food to them. Yet, since the smart catering truck is above the corridor, except those seated next to the corridor, the smart catering truck is beyond reach of other passengers. Moreover, the food for the economy class is limited and therefore, the design of order according to need is basically impractical. The so-called intelligent service requires relatively high quality of passengers. It is difficult to realize such conception in the economy class. Therefore, the smart catering truck is more suitable for the passengers of business class and first-class cabins of large aircraft but cannot fulfill the demands of the economy class.

In contrast, the design of suspended catering truck is applicable for liquid drink service because a liquid drink service truck hung in the ceiling is able to satisfy the demand of a number of passengers for liquid drink service. A design plan of catering truck that provides liquid drinks is provided as follows. The catering truck is hung in the ceiling and travels above the corridor in the cabin to offer food service for passengers. As to the design put forward by Seongjoo JOH and Lee Min-Joo about a catering truck travelling along the central line of the ceiling above the corridor, passengers still have to bend over when passing the suspended catering truck. Therefore, the suspended catering truck of this invention maintains its characteristics that it travels along either side of the corridor with the truck body not exceeding the vertical side of the central line of the corridor.

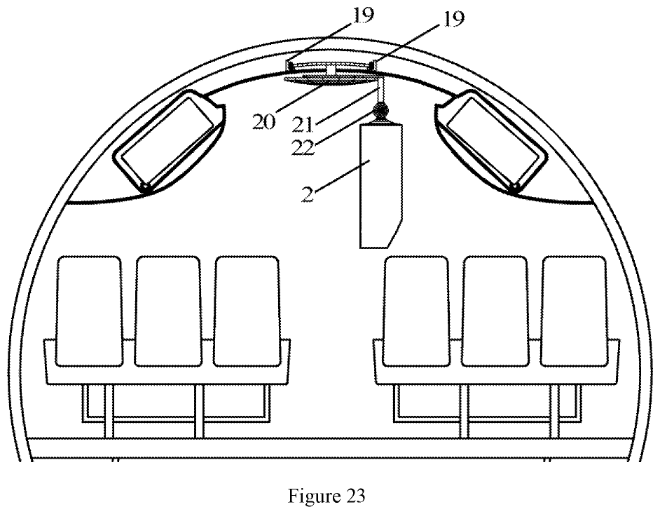

As shown in FIGS. 23 and 24, they are respectively the profile sketch of the cabin when the catering truck of the 7th embodiment of this invention in use above the corridor and the profile sketch of the cabin when the catering truck of the 7th embodiment of this invention folded and stored in the ceiling. FIG. 23 indicates that there is a pair of rails built in the ceiling of the cabin. To diffuse the stress on the top of the cabin, the rails 19 are divided into the left and right parts. The motor truck 20 is mounted on the left and right rail 19 with the wheels installed in the ceiling of which the body is exposed in the air under the ceiling. To maintain a nice appearance and reduce cutting in the ceiling, there is only a gap for the motor truck 20 above the corridor so that the connecting piece between the wheels and the body of the motor truck 20 passes through the gap. The body of the motor truck 20 is of disk-like structure at the diameter similar to the width of the corridor and the bracket 21 is installed on one side of the disk-like body so that it can rotate around the central axis of the disk-like body. The truck compartment 2 is hung on the bracket 21. When the bracket 21 rotates around the central axis of the body of the motor truck 20 at 0 degree or 180 degrees, the truck compartment 2 above the corridor will respectively face the left and right side of the vertical surface corresponding to the center line of the corridor and will not cross the center line of the corridor. When the bracket 21 rotates around the central axis of the body of the motor truck 20 at 90 or 270 degrees, the truck compartment 2 above the corridor will go perpendicular with the center line of the corridor. To give strong pull to the catering truck on one side above the corridor, the left part of the rails 19 is supposed to be above the catering truck when it is in use at the left side above the corridor. Similarly, the right part of the rails 19 is supposed to be above the catering truck when it is in use at the right side above the corridor. The bracket 21 connecting the truck compartment 2 and the motor truck 20 has a collapsible running axis 22 which rotates inward at 90 degrees. When not in use, the truck compartment 2 will rotate around the truck body at 90 degrees until it goes perpendicular with the corridor and then rotate around the collapsible running axis 22 towards the ceiling at 90 degrees so that the catering truck can be collapsed and stored in the ceiling. As shown in FIG. 24, it is the profile sketch of the cabin when the catering truck of the 7th embodiment of this invention folded and stored in the ceiling.

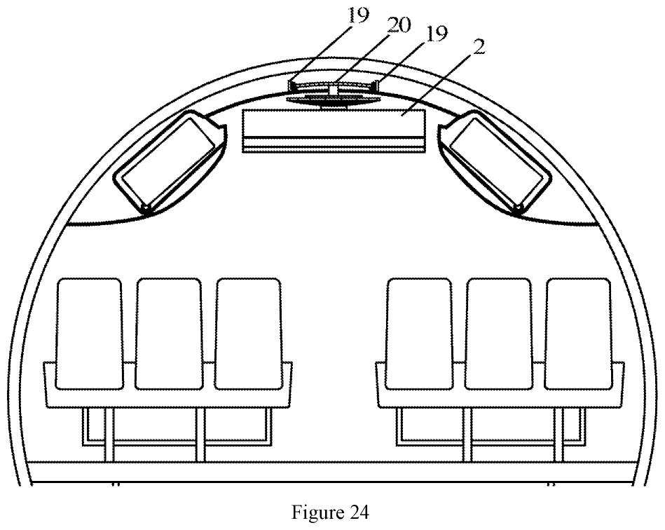

As shown in FIG. 25, it is the perspective of the 8th design of drink pots of this invention based on the 7th embodiment of catering truck of this invention. The design has a handle at the higher position while the faucet 4 and the faucet switch 5 can be found at the bottom of the drink pot.

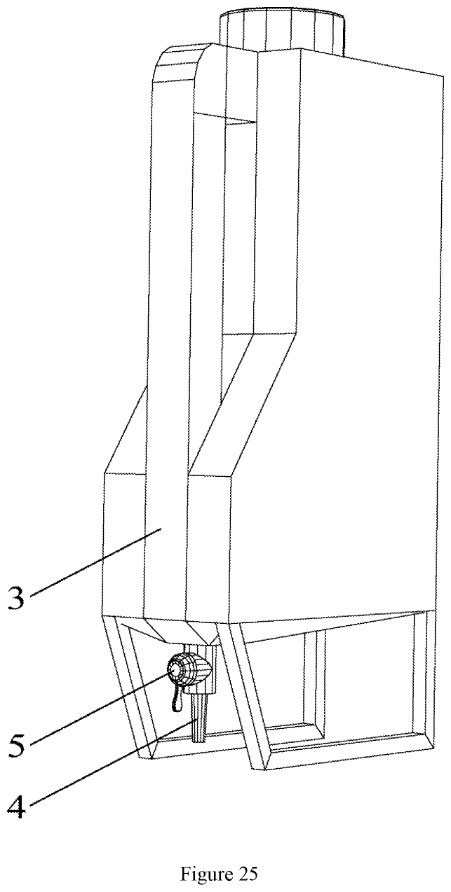

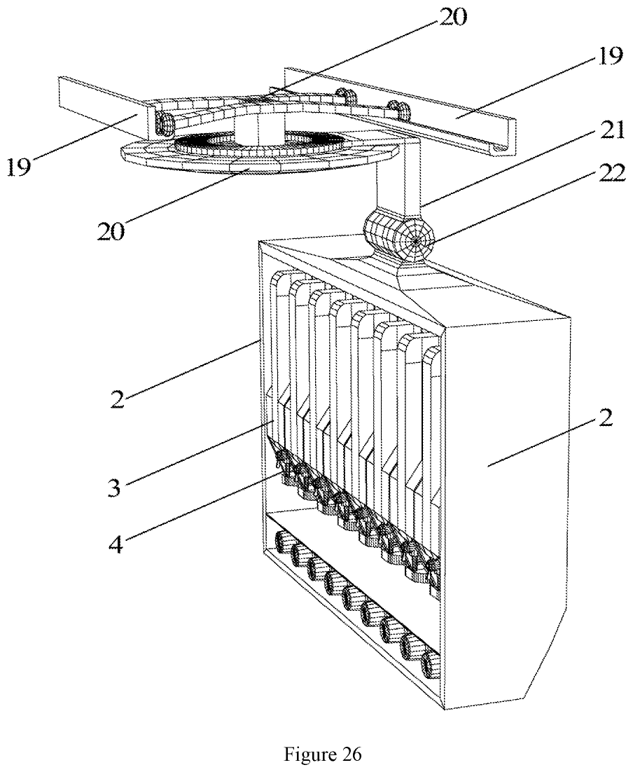

As shown in FIG. 26, it is the perspective of the 7th embodiment of this invention. FIG. 26 indicates that, to diffuse the stress on the top of the cabin, the rails 19 are divided into the left and right parts. The motor truck 20 is mounted on the left and right rail 19. The body of the motor truck 20 is a disk-like structure at the diameter similar to the width of the corridor. The bracket 21 is installed on one side of the disk-like body so that it can rotate around the central axis of the disk-like body. The bracket 21 has a collapsible running axis 22 which rotates inward at 90 degrees so that the catering truck can be collapsed and stored in the ceiling. Since the catering truck is stored in the ceiling, the idea of power supply is feasible. Therefore, the collapsible running axis 22 can be a motor-driven or hydraulic device or the simple, economical and reliable mechanical ratchet is adopted. When the truck compartment 2 rotates towards the ceiling, the ratchet-structured collapsible running axis 22 will automatically lock the truck compartment. The truck compartment 2 can be released by pressing the unlock button to remove the ratchet. It is a common technical solution acknowledged by the technical personnel in the field. Therefore, no further details are provided herein. FIG. 26 does not offer any further details, either. As shown in FIG. 26, when the drink pots are removed from the catering truck, the catering truck can also be used as a food service truck to deliver food.

The foregoing 7th embodiment of catering truck also provides food service. Yet, since the truck compartment is comparatively small and has a limited capacity, only a limited quantity of food is available each time. To satisfy the considerable demands for food service of the economy-class passengers, the following technical solution of travelling multiple suspended catering truck in the cabin is offered.

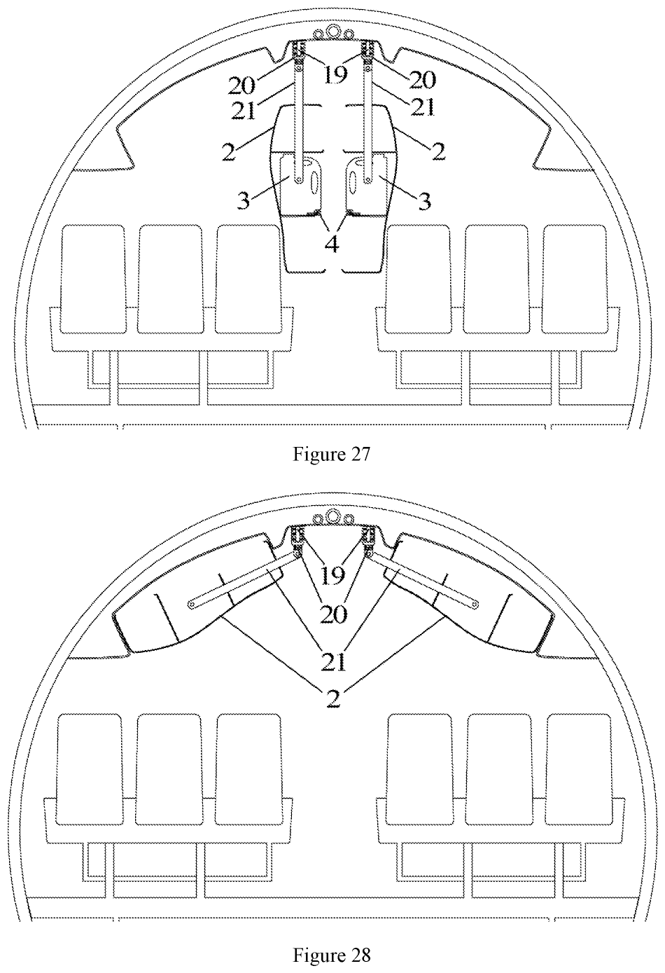

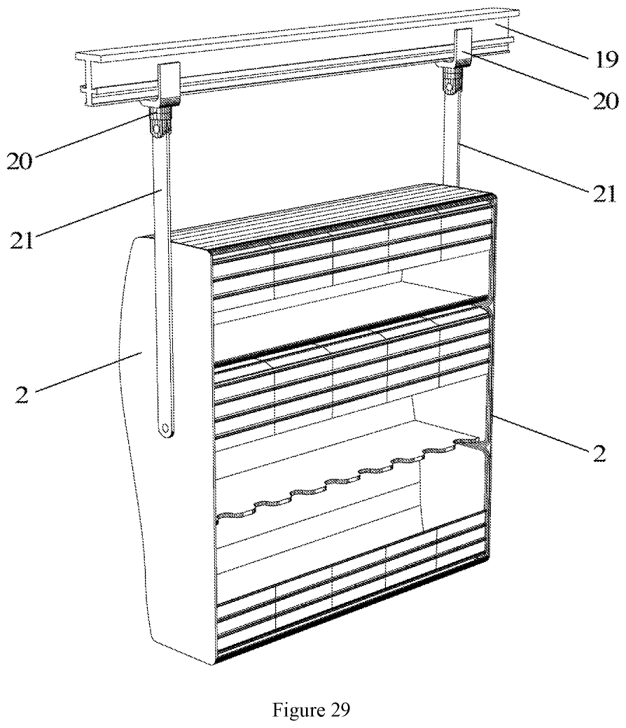

As shown in FIGS. 27, 28 and 29, they are respectively the sectional sketch of the cabin when the catering truck of the 8th embodiment of this invention is in service, the sectional sketch of the cabin when the catering truck of the 8th embodiment of this invention is stored in a luggage rack and the perspective of the 8th embodiment of this invention. According to the embodiment, the rails 19 mounted on both sides of the vertical surface to the central line of the cabin in the ceiling between the corridor with the motor truck 20 mounted on the rails 19, the bracket 21 connected to the motor truck 20 and the truck compartment 2 connected to the bracket 21. The motor truck 20 and the bracket 21 are respectively composed of the front and rear parts which are separately installed on the back and front of the truck compartment 2. The bracket 21 rotates round the connecting axis of the motor truck 20 while the truck compartment 2 rotates around the connecting axis of the bracket 21 so that the truck compartment 2 is mounted on the rails 19 and hung in the air as a swing. The truck compartment 2 is equipped with drink pots 3 with faucets 4 at the bottom. When used as a food service truck, the drink pots 3 are removed. As shown in FIG. 27, symmetric design composed of the rails 19, motor truck 20, bracket 21 and truck compartment 2 of the catering truck is set in the ceiling at the other side beside the vertical surface of the central line of the cabin. The symmetric catering trucks at both sides under the ceiling occupy the space at both side of the central line above the corridor. Both truck bodies 2 are required to stay a certain distance from the vertical surface of the central line and travel along the corridor asynchronously. FIG. 27 illustrates the asynchronous position and relation of the two symmetric catering trucks. As shown in FIG. 28, when not in use, the truck compartment 2 can be rotated. Driven by the bracket 21, it swings towards the luggage rack until it is hung on the luggage rack. When in use, the cabin attendants can take off the catering truck from the bin. Since the truck compartment is hung on the rails 19, the operation is easy and convenient and the catering trucks will not take up any floor space of the cabin. As shown in FIG. 29, the truck compartment 2 is divided into three layers with the middle layer having the boards for placement of the drink pots 3 with faucets 4 at the bottom. During liquid drink service, the drink pots can be directly placed in the middle layer. In contrast, during food service, the drink pots can be removed from the middle layer so that the meal boxes can be placed in all of the upper, middle and lower layers. Taking the liquid drink and food services into consideration, FIG. 29 also indicates that the doors of the upper, middle and lower layers of the truck compartment 2 are of the rolling-blind structure. During liquid drink service, the rolling blind will curl up to expose the faucets whereas during food service, the rolling blinds will slowly curl up according to the delivery progress to prevent the meal boxes from falling down. On the inner walls of the side boards of the truck compartment 2, there are rails for the rolling blinds of the three layers.

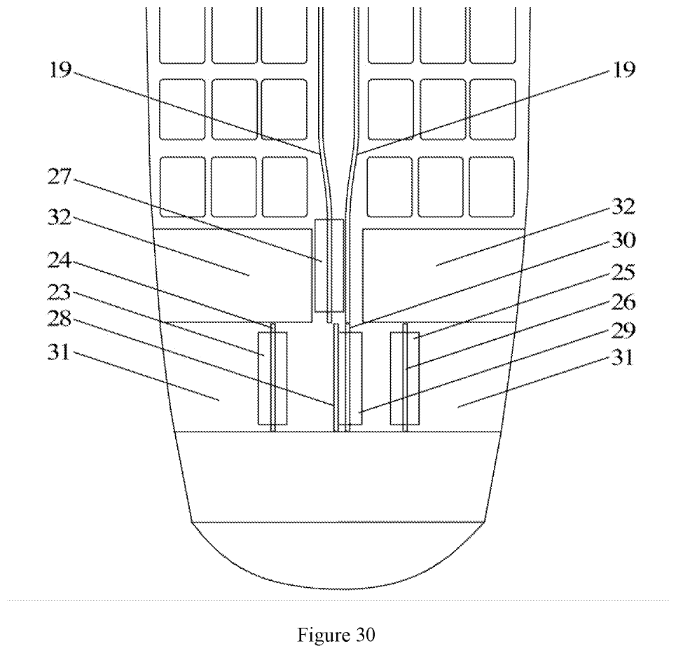

As shown in FIG. 30, it is the vertical view of the kitchen when the catering trucks of the 8th embodiment of this invention gather above the corridor floor of the kitchen. The sketch illustrates that the 8th embodiment of this invention offers a technical solution to the situation when there are four catering trucks gathered in the kitchen of aircraft. As shown in FIG. 30, the left and right rails are separated at the position above the kitchen and therefore the separate rails are form. The quantity of separate rails should be the same as that of the catering trucks. In FIG. 30, there are 4 catering trucks marked with the FIGS. 1, 2, 3 and 4, which respectively correspond to the separate rails 1, 2, 3 and 4. The separate rails 1 and 3 correspond to the left part of the rails 19 and slide along the left side of the cabin whereas the separate rails 2 and 4 correspond to the right part of the rails 19 and slide along the right side of the cabin. When the catering trucks slide to the corresponding separate rails, they will automatically leave the main rail and reach the separate rails. For large aircraft such as Airbus A380 or Boeing 787, the kitchen is relatively large and the ceiling of the kitchen is flat, one of the feasible designs of separate rails 1, 2, 3 and 4 is rotary separate rails that drive the catering trucks from the main rails to the rotary separate rails so that the catering trucks gather above the corridor floor of the kitchen 31 and cabin attendants can load or unload the catering trucks conveniently in the kitchen 31. FIG. 30 illustrates the positions and order of the four catering trucks and the corresponding separate rails when they gather in the kitchen. As shown in FIG. 30, considering that, in some aircraft, the corridor outside the restroom 32 is narrower than that of the economy-class cabin, to ensure that the catering trucks pass the narrower corridor smoothly, and the left and right part of the rails 19 can be set closer to the central line of the corridor.

The utility of a new design requires comprehensive consideration of every element. The suspended catering trucks hung in the ceiling at the top of the aircraft described by the 7th and 8th embodiments of this invention put forward higher requirements for the structure of aircraft, particularly the support structure of the cabin. In addition, the realization of the embodiments requires changes in the design of ceilings of aircraft. It is related to systems engineering involving extensive aspects. Therefore, it is highly possible that the embodiments fail to come to utility. To produce the more practical design plans, it is required to carry out careful observance of cabins so that the limited space can be fully utilized. This invention insists that the catering trucks put into use should only occupy one side of the corridor; no matter it is the floor space or the space above the corridor. Upon careful observance of the cabins, it is discovered that it is more feasible and reasonable to occupy the space above the corridor. To make the best of the space above the corridor in an innovative way without changing the design of the ceilings, the luggage rack is used for storage of catering trucks which also in line with the design of rails. Other new embodiments are provided as follows.

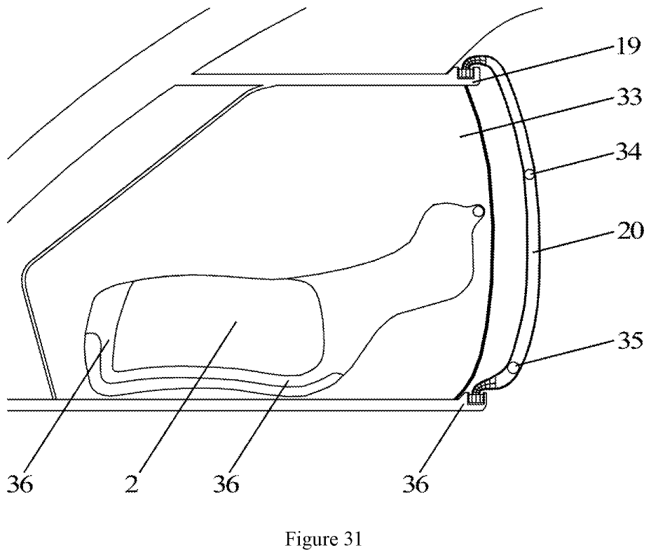

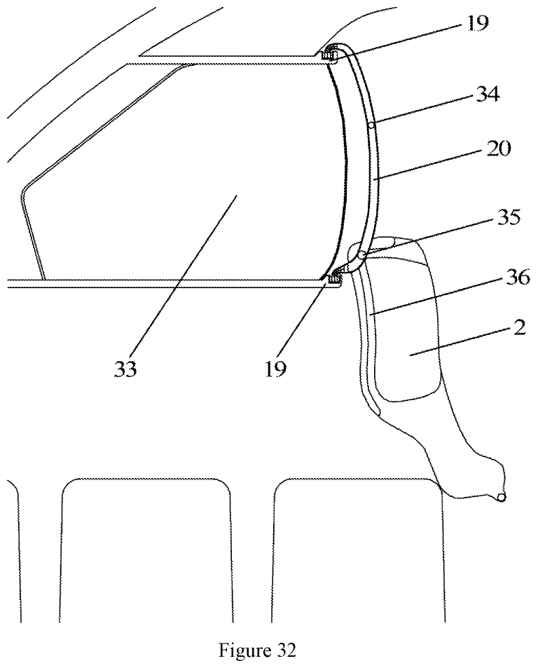

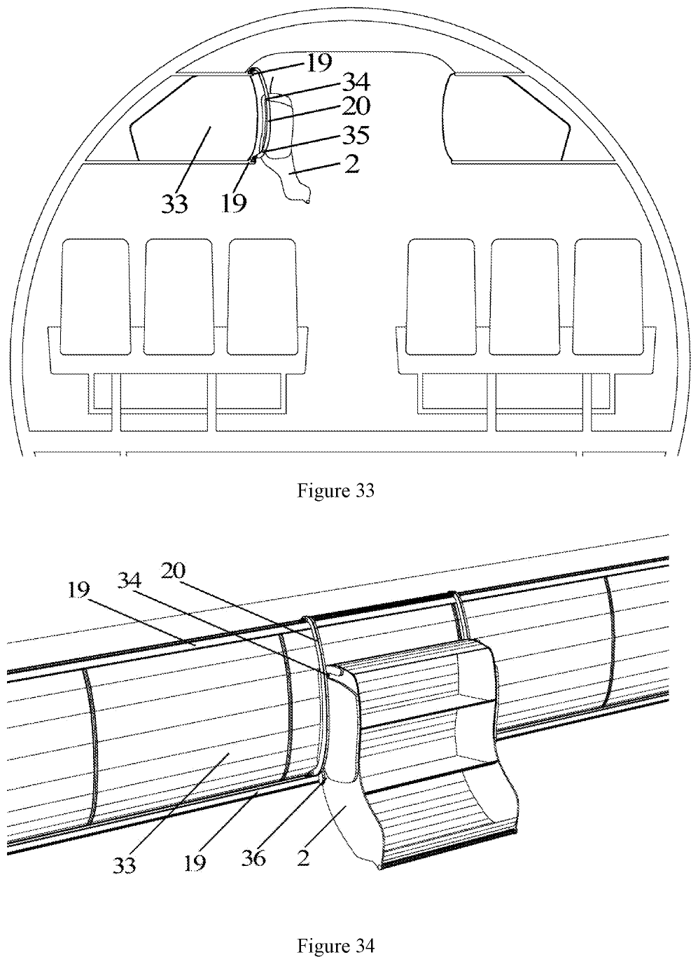

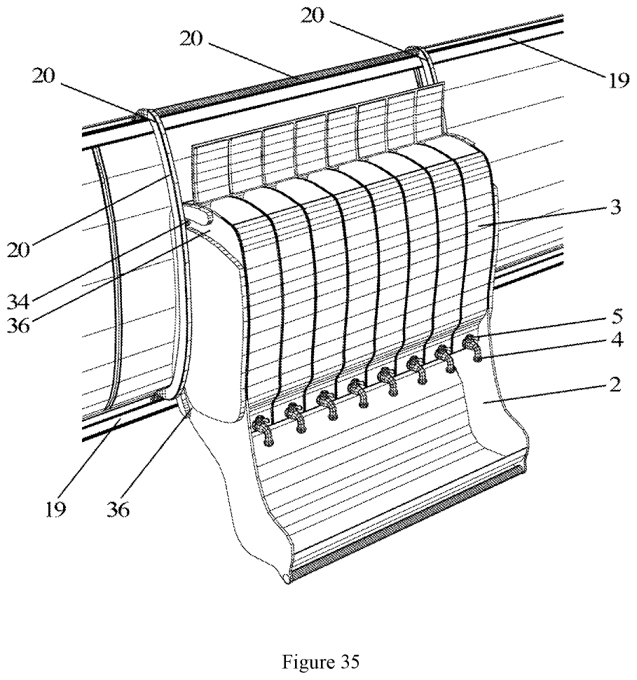

As shown in FIGS. 31, 32, 33, 34 and 35, they are respectively the local sectional sketch of the cabin when the catering truck of the 9th embodiment of this invention is stored in a luggage rack, the local sectional sketch of the cabin when the catering truck of the 9th embodiment of this invention is at the lower position, the sectional sketch of the cabin when the catering truck of the 9th embodiment of this invention is in service, the perspective of the 9th embodiment of this invention and the perspective of the 9th design of drink pots of this invention. FIGS. 31, 32, 33 and 34 show that there is a pair of rails 19 on the luggage rack 33, which are composed of the upper rail 19 on the upper edge of the luggage rack 33 and the lower rail 19 on the lower edge of the luggage rack 33. Outside the luggage rack 33, there is a motor truck 20 mounted on the upper and lower rails 19. The truck compartment 2 is mounted on the motor truck 20. The motor truck 20 is a square rack mounted between the upper and lower rails and next to the luggage rack 33. The upper suspended wheels 34 and lower suspended wheels 35 are installed in the inner side of the rack. There are mirror-symmetric “7” shaped concave guide ways 36 on the side boards at both sides of the truck compartment 2. Each pair of concave guide ways 36 has flaring ends at both sides for the convenience of installing the upper suspended wheels 34 and the lower suspended wheels 35 on the guide ways. When the truck compartment 2 is pulled out from the compartment, the lower suspended wheels 35 will be hung on the concave guide ways 36 from the lower end. Driven by the lower suspended wheels 35 and the concave guide ways 36, the truck compartment 2 will slide to the lowest position. When the lower suspended wheels 35 and the concave guide ways 36 reach the turning point at the top, the truck compartment 2 is hung on the lower suspended wheels 35 with the bottom lying on the passenger seat under it, which is for the purpose of loading food in the truck compartment 2 and refilling the drink pots 3. Then, the truck compartment 2 will be driven upward. When the upper end of the concave guide ways 36 reaches the position of the upper suspended wheels 34, the upper suspended wheels 34 will be installed on the concave guide ways 36. When the upper suspended wheels 34 reach the turning point of the concave guide ways 36 at the top, the truck compartment 2 will be hung on the upper suspended wheels 34 and the lower suspended wheels 35 will stay at the lower part of the concave guide ways 36 to support and fix the truck compartment 2. To make it easier to push the heavy truck compartment 2 from the lower suspended wheels 35 to the upper suspended wheels 34, the connecting rod under the square rack of the motor truck 20 also can be equipped with wheels so that the wheels can reduce the friction and provide support to the truck compartment 2 when it is pulled out from the luggage rack 33 or pushed from a lower position to a higher one. As shown in FIG. 34, it is the perspective of the 9th embodiment of this invention, in which the truck compartment 2 without meal boxes is hung in the luggage rack 33. As shown in FIG. 35, it is the perspective of the 9th design of drink pots of this invention as well as the perspective of the 9th embodiment of this invention when the catering truck is used as a liquid drink service truck. Integrated design is applied to the drink pots in FIG. 35. In other words, the eight drink pots are connected as an integrated part with each drink pot having a faucet 4 at the bottom so that cabin attendants can pour liquid drinks for passengers by turning on the faucet switch 5. Comparing FIG. 34 and FIG. 35, it is discovered that the truck compartment 2 should have a relatively large capacity when the catering truck is used as a food service truck. Therefore, when used as a food service truck, a separate design is produced upon consideration of the stress condition of the luggage rack as well as the motor truck and the space of the luggage rack to maximize the capacity of the truck compartment 2.

The drink pots in the embodiments can be made of transparent materials so that the cabin attendants can easily identify the liquid drinks and passengers can make quick choices by directly viewing all liquid drinks. When the drink pots are placed in the truck compartment or the transparent materials are not applicable and therefore neither the cabin attendants nor the passengers can see the liquid drinks directly, stickers with the names of different liquid drinks applied to the truck compartment or the drink pots for the convenience of identification.

This invention aims to solve the primary problems and assist cabin attendants in serving passengers. Taking full consideration of the practicability, feasibility and user-friendly principle, the first six embodiments make no change to any of the existing structures of aircraft but producing functional deigns based on the existing catering trucks. After the production is completed, the products are directly put into use. It is easy, user-friendly, low-cost, high efficient and practical. Although the 7th, 8th and 9th embodiments require changes of the cabin design of the existing aircraft, the embodiments are much more practical and are sure to assist the cabin attendants in providing increasingly efficient and fast service to passengers, which, in the meanwhile, highly relieve the heavy burden of cabin attendants when serving passengers and improve the service quality.

1. A catering truck on an aeroplane characterized in that: such catering truck can be divided into four kinds of catering trucks: one that travels along the corridor floor of an aeroplane, or is suspended and travels along the central rail installed in the ceiling over the corridor; or is suspended and travels along the rails installed on either side above the corridor; or hangs on and travels along the rails installed on the luggage rack; The bottom board of the compartment of the catering truck that travels along the corridor floor of an aeroplane ascending horizontally and lifting the meals in the compartment horizontally for cabin attendants to fetch the meals over the catering truck, the catering truck travelling on the corridor floor of an aeroplane utilizes an “X” shaped strut to achieve the horizontal ascending and descending of the bottom board of the compartment, the truck compartment having an ascending and descending rotary plate at the top and the “X” shaped strut at the bottom, the bottom board being above the “X” shaped strut, a screw being under the “X” shaped strut, the ascending and descending rotary plate being connected with the screw by belt drive, chain drive or transmission shaft drive, the screw rotating as the ascending and descending rotary plate rotates, the mirror-symmetric screw threads on the screw from the middle to both ends pulling together or pushing away the bottom sides of the “X” shaped strut connected to the screw threads, the bottom board ascending when pulling together the said bottom sides, the bottom board descending when pushing away the said bottom sides; The catering truck suspended and traveling along the central rail installed in the ceiling above the corridor comprises rails, a motor truck, a bracket, a collapsible rotary shaft and a truck compartment, the rails being built in the ceiling, the motor truck being mounted on the rails, the wheels of the motor truck being installed in the ceiling and the body being exposed in the air under the ceiling, a gap being provided in the center of the ceiling above the corridor for the motor truck, the connecting piece between the wheels and the body of the motor truck travelling through the gap, the body of the motor truck being a disk-like structure, the bracket being installed on one side of the disk-like body, enabling rotation around the central axis of the disk-like body, the truck compartment being suspended on the bracket, the positions of the truck compartment above the corridor respectively facing the left and right side of the vertical surface corresponding to the center line of the corridor when the bracket rotates around the central axis of the motor truck body at 0 degree and 180 degrees, such positions not exceeding the vertical surface of the center line of the corridor, the truck compartment being positioned at the center over the corridor perpendicular with the corridor when the bracket rotates around the central axis of the motor truck body at 90 and 270 degrees, the bracket having a collapsible rotary shaft, the rotary shaft rotating inward at 90 degrees, the truck compartment rotating to a position perpendicular with the corridor and then rotating at 90 degrees towards the ceiling along the collapsible rotary shaft to collapse and store the catering truck in the ceiling when the catering truck is not in use; The catering truck suspended on and traveling along the rails installed on either side over the corridor comprises rails, a motor truck, a bracket and truck compartment, the rails being mounted on one side of the vertical surface of the central line of the cabin corridor, the motor truck being on the rails, the bracket being connected to the motor truck; The truck compartment being connected to the bracket, the motor truck and the bracket comprising the front and rear parts respectively positioned on the front and rear end of the truck compartment, the bracket rotating along the connecting axis with the motor truck, the truck compartment rotating along the connecting axis with the bracket, so that to make the truck compartment suspended on the rails in the structure as a swing, the truck compartment rotating and swinging towards the position of the luggage rack as effected by the bracket and hang and store the truck compartment at the luggage rack when the catering truck is not in use, the catering truck being taken off from the luggage rack and the truck compartment still being suspended on the rails when the catering truck is in use; The catering truck suspended on and traveling along the rails installed on the luggage rack of an aeroplane comprises rails, a motor truck and a truck compartment, the rails consisting of an upper rail and a lower rail, the upper rail being mounted on the upper edge of the luggage rack, the lower rail being mounted on the lower edge of the luggage rack, the motor truck being designed at the outer side of the luggage rack, the motor truck being mounted on the upper and lower rails, the truck compartment being on the motor truck, the truck compartment running outside the luggage rack, the truck compartment being stored in the luggage rack when not in use, the truck compartment being pulled out from the luggage rack and hung on the motor truck when in use.

2. The said catering truck on aeroplane according to claim 1 is characterized in that: the said catering truck is designed to have supporting drink pots, each drink pot being filled with a different liquid drink and having a respective faucet, cabin attendants pouring liquid drinks for passengers with faucet switches, the faucet either being positioned at the bottom of the drink pot, the liquid drink in it flowing to the faucet driven by gravity, or being positioned at the top of the drink pot, the liquid drink flowing to the faucet driven by high-pressure gas.

3. (canceled)

4. (canceled)

5. The said catering truck on aeroplane according to claim 1 is characterized in that: the length and width of the base of the said catering truck traveling along the corridor floor of an aeroplane are identical to the length and width of the base of the existing catering trucks, the said catering truck being “I” shaped or “[” shaped when viewed from the top, the four wheels being positioned at the four corners of the “I” shape or “[” shape, the length and height of the truck compartment being identical to the length and height of the existing catering truck, the width being half or less than half of the width of the corridor, the truck compartment with the base of the “I” shape being positioned at the center above the base, the truck compartment with the base of the “[” shape being positioned at one side above the base.

6. The said catering truck on aeroplane according to claim 1 is characterized in that: the said catering truck traveling along the corridor floor of an aeroplane comprises a high-pressure gasholder, the high-pressure gasholder transmitting the high-pressure gas through the gas pipe to the upper space of the drink pot, the liquid drink in the drink pot being delivered to the faucet positioned above the drink pot under the pressure of the high-pressure gas.

7. The said catering truck on aeroplane according to claim 1 is characterized in that: the said catering truck suspended on and traveling along the rails installed on one side of the ceiling above the corridor, the ceiling on the other side of the vertical surface of the central line of the corridor of the cabin of the aeroplane having symmetrically designed rails, a motor trucks, brackets and truck compartments, the symmetrically designed catering trucks on both sides occupying the space on both sides of the central line above the corridor, both truck compartments not exceeding the vertical surface of the central line of the corridor, the two symmetrically designed catering trucks passing across each other above the same corridor.

8. The said catering truck on aeroplane according to claim 1 is characterized in that: the rails of the said catering truck suspended on and traveling along the rails installed on either side above the corridor have two or more catering trucks, the segment of the rails over the airline kitchen being disconnected to form separate rails, the number of separate rails being identical to the number of the catering trucks, the separate rails sliding or rotating towards either side of the cabin, the catering trucks being led off the rails when the catering trucks slide to the separate rails that slide or rotate towards either side of the cabin to achieve the purpose that the catering trucks are gathered above the corridor of the kitchen, facilitating mass loading and unloading in the kitchen by cabin attendants.

9. The said catering truck on aeroplane according to claim 1 is characterized in that: the motor truck of the said catering truck suspended and traveling along the rails mounted on the luggage rack is a square frame mounted between the upper and lower rails at the outer side of the luggage rack, the upper suspended roller wheels and lower suspended roller wheels being installed in the inner side of the frame, concave guide ways being installed on the side boards on both sides of the truck compartment, the concave guide ways having flaring ends to allow the upper suspended roller wheels and the lower suspended roller wheels to enter the concave guide ways, when the truck compartment being pulled out from the luggage rack, the lower suspended roller wheels entering the concave guide ways from the lower end, the truck compartment sliding to the lowest position as guided by the lower suspended roller wheels and the concave guide ways, the lower suspended roller reaching the corner at the top of the concave guide ways, at this point, the truck compartment hanging on the lower suspended roller wheels, the bottom of the truck compartment lying on the passenger seat below at such position and height for the purpose of placing meal boxes inside the truck compartment or refilling each drink pot, after placing meal boxes and refilling liquid drinks, the truck compartment being pushed upward, when the upper end of the concave guide ways reaching the position of the upper suspended roller wheels, the upper suspended roller wheels entering the concave guide ways and reaching the corner at the top of the concave guide ways, at this point, the truck compartment being hung on the upper suspended roller wheels, the lower suspended roller wheels being positioned below the concave guide ways to support and secure the truck compartment.

10. The said catering truck on aeroplane according to claim 2 is characterized in that: a faucet is positioned at the bottom or top of the said drink pot, such faucet being rotated and stored in the body, leg or handle of the drink pot when not in use for the convenience of storage, the faucet being rotated outward when in use, the outlets being stretched out of the body of drink pot for the convenience of filling liquid drink.
